(19) United States
(12) Patent Application Publication
(10) Pub. No.: US 2026/0355628 A1
(43) Pub. Date: Nov. 12, 2026

(54) MATCH METHOD AND APPARATUS, COMPUTER DEVICE, AND STORAGE MEDIUM

(71) Applicant: Tencent Technology (Shenzhen) Company Limited, Shenzhen (CN)

(72) Inventor: Ziqi WEI, Shenzhen (CN)

(21) Appl. No.: 19/731,763

(22) Filed: Jul. 6, 2026

Related U.S. Application Data
(63) Continuation of application No. PCT/CN2025/104474, filed on Jun. 27, 2025.

(30) Foreign Application Priority Data
Aug. 13, 2024 (CN) 202411114449.0

(51) Int. Cl. A63F 13/533; A63F 13/5372; A63F 13/822

(52) U.S. Cl. CPC A63F 13/533; A63F 13/5372; A63F 13/822; A63F 2300/308

(57) ABSTRACT

Provided are a virtual match method performed by a computer device. The method includes: displaying a match interface of a round-based board game, a plurality of virtual pieces and first battle information being displayed on the match interface; displaying, in response to a virtual match starting, that the plurality of virtual pieces engage in battle according to a battle relationship; and displaying victory prompt information on the match interface when the virtual match ends, the victory prompt information indicating a winner among the plurality of virtual pieces. This application implements a novel match method, and allows the virtual pieces corresponding to a plurality of participants to engage in battle in a same image. This enriches battle manners between the participants, and improves an interactive effect. In addition, players do not need to perform complex operations to deploy pieces. This improves human-computer interaction efficiency.

### CROSS-REFERENCE TO RELATED APPLICATIONS

This application is a continuation application of PCT Patent Application No. PCT/CN2025/104474, entitled “MATCH METHOD AND APPARATUS, COMPUTER DEVICE, AND STORAGE MEDIUM” filed on Jun. 27, 2025, which claims priority to Chinese Patent Application No. 202411114449.0, entitled “MATCH METHOD AND APPARATUS, COMPUTER DEVICE, AND STORAGE MEDIUM” filed on Aug. 13, 2024, both of which are incorporated herein by reference in their entirety.

### FIELD OF THE TECHNOLOGY

Embodiments of this application relate to the field of computer technologies, and in particular, to a match method and apparatus, a computer device, and a storage medium.

### BACKGROUND OF THE DISCLOSURE

A round-based board game is a type of multiplayer battle board game in which battle participants can place pieces on a chessboard. A game application pairs up the battle participants, automatically controls the pieces of two battle participants on the chessboard to engage in battle, and displays a battle result. Health points of a loser are deducted, and final rankings are determined based on an elimination order.

### SUMMARY

Embodiments of this application provide a match method and apparatus, a computer device, and a storage medium, to improve an interactive effect, and improve human-computer interaction efficiency. The technical solutions are described as follows:

According to an aspect, a virtual match method is performed by a computer device. The method includes:
displaying a graphical user interface of a virtual chessboard, the virtual chessboard including a plurality of candidate virtual pieces;
in response to a selection operation for a new virtual piece, highlighting the new virtual piece on the virtual chessboard, the new virtual piece being any one of the plurality of candidate virtual pieces;
in response to a match initiation instruction, switching the graphical user interface from the virtual chessboard to a match interface having a plurality of virtual pieces including the new virtual piece and first battle information, the first battle information indicating a one-to-one battle relationship between the plurality of virtual pieces;
in response to a virtual match starting instruction, causing the plurality of virtual pieces to engage in one-to-one battles according to the one-to-one battle relationship; and
when the virtual match ends, displaying victory prompt information on the match interface identifying a winner among the plurality of virtual pieces.

According to another aspect, a computer device is provided. The computer device includes a processor and a memory. The memory has at least one computer program stored therein, and the at least one computer program is loaded and executed by the processor to implement operations performed in the match method according to the foregoing aspect.

According to another aspect, a non-transitory computer-readable storage medium is provided. The computer-readable storage medium has at least one computer program stored therein, and the at least one computer program is loaded and executed by a processor to implement operations performed in the match method according to the foregoing aspect.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

### BRIEF DESCRIPTION OF THE DRAWINGS

FIG. 1 is a structural block diagram of a computer system according to an embodiment of this application.

FIG. 2 is a flowchart of a match method according to an embodiment of this application.

FIG. 3 is a flowchart of another match method according to an embodiment of the present application.

FIG. 4 is a schematic diagram of a match interface according to an embodiment of this application.

FIG. 5 is a schematic diagram of another match interface according to an embodiment of this application.

FIG. 6 is a schematic diagram of still another match interface according to an embodiment of this application.

FIG. 7 is a schematic diagram of still another match interface according to an embodiment of this application.

FIG. 8 is a schematic diagram of still another match interface according to an embodiment of this application.

FIG. 9 is a schematic diagram of still another match interface according to an embodiment of this application.

FIG. 10 is a flowchart of still another match method according to an embodiment of this application.

FIG. 11 is a schematic diagram of still another match interface according to an embodiment of this application.

FIG. 12 is a flowchart of still another match method according to an embodiment of this application.

FIG. 13 is a schematic diagram of still another match interface according to an embodiment of this application.

FIG. 14 is a flowchart of still another match method according to an embodiment of this application.

FIG. 15 is a schematic diagram of a virtual chessboard interface according to an embodiment of this application.

FIG. 16 is a schematic diagram of another virtual chessboard interface according to an embodiment of this application.

FIG. 17 is a flowchart of still another match method according to an embodiment of this application.

FIG. 18 is a schematic diagram of still another virtual chessboard interface according to an embodiment of this application.

FIG. 19 is a flowchart of still another match method according to an embodiment of this application.

FIG. 20 is a schematic structural diagram of a match apparatus according to an embodiment of this application.

FIG. 21 is a schematic structural diagram of a terminal according to an embodiment of this application.

FIG. 22 is a schematic structural diagram of a server according to an embodiment of this application.

### DESCRIPTION OF EMBODIMENTS

Terms “first”, “second”, “third”, “fourth”, “fifth”, “sixth”, and the like used in this application may be used for describing various concepts herein. However, unless otherwise specified, the concepts are not limited by the terms. These terms are merely configured for distinguishing one concept from another. For example, without departing from the scope of this application, a first virtual piece may be referred to as a second virtual piece, and similarly, a second virtual piece may be referred to as a first virtual piece. In terms “at least one”, “a plurality of”, “each”, and “any one” used in this application, “at least one” includes one, two, or more, “a plurality of” include two or more, “each” refers to each of a plurality of corresponding items, and “any one” refers to any one of a plurality of items. For example, a plurality of virtual pieces include three virtual pieces. “Each” refers to each of the three virtual pieces. “Any one” refers to any one of the three virtual pieces, and may refer to a first virtual piece, or a second virtual piece, or a third virtual piece.

Information (including but not limited to user equipment information, user personal information, and the like), data (including but not limited to data configured for analysis, stored data, presented data, and the like), and signals involved in this application are all authorized by a user or fully authorized by various parties, and collection, use, and processing of related data need to comply with relevant laws, regulations, and standards of relevant countries and regions. For example, first battle information or prompt information involved in this application is obtained with full authorization.

In a battle method in the related art, simple content is displayed during a battle. In addition, the battle method has high requirements for players, as players need to learn a piece layout manner to win easily. This results in a poor interactive effect of a round-based board game match.

Round-based board game: it refers to a board game in which “virtual pieces” are deployed in advance before a board match starts, and the “virtual pieces” can automatically engage in battle according to the pre-determined layout during the battle. A “virtual piece” is typically represented by a virtual character, and for example, may be referred to as a virtual hero. During the battle, the virtual character automatically casts various skills for the battle. The battle typically is round-based. When “virtual pieces” of one battle party are all defeated (that is, health points of the virtual characters drop to zero), the party is determined as a loser of a current round. In some embodiments, in addition to “virtual piece-type virtual characters” engaging in a battle, both battle parties are respectively provided with one chess player character representing a current user participating in the battle. The chess player character cannot be moved to a battle area or a virtual piece candidate area as a “virtual piece”. The chess player character also has health points (or hit points). The health points of the chess player character are correspondingly reduced (losing the battle) or not changed (winning the battle) based on a battle result of each round. When the health points of the chess player character drop to zero, the user corresponding to the chess player character exits the battle, and the remaining users continue the battle. In an embodiment, the round-based board game includes auto chess.

Auto chess: it is a type of multiplayer round-based competitive game with in-game collectible hero virtual pieces. For example, a total of eight or six players participate in a game and each occupy an area of a chessboard. Two of the plurality of players engage in a one-on-one battle. Each round of a battle includes two phases: a battle preparation phase and a battle phase. In the battle preparation phase, users purchase virtual pieces (heroes) from a store and deploy the virtual pieces on a chessboard. In the battle phase, lineups of both parties are locked, and the virtual pieces automatically engage in battle until virtual pieces of one party are all defeated. A player whose virtual pieces are all defeated is a loser of a current round, and health points are deducted by a specific amount. Game rounds are continuously repeated, and the player is matched with new opponents and eliminated from the match until the health points of the player is less than or equal to 0. The last remaining player will win the game (the 1^{st} place).

Chessboard: it refers to an area on a battle interface of a round-based board game configured for preparing and conducting battles. The chessboard may be any one of a two-dimensional virtual chessboard, a 2.5-dimensional virtual chessboard, and a three-dimensional virtual chessboard. This is not limited in this application. A chessboard of auto chess is divided into a battle area and a virtual piece candidate area. The battle area includes several chess grids of equal size. The chess grid is configured for placing a virtual piece that engages in a battle during the battle. The virtual piece candidate area includes several candidate virtual piece positions. The candidate virtual piece position is configured for placing the candidate virtual piece. The candidate virtual pieces do not engage in battle during a battle and can be dragged to and placed in the battle area in the battle preparation phase.

Regarding an arrangement manner of chess grids in the battle area, in some embodiments, the battle area includes n (rows)×m (columns) squares. Exemplarily, n is an integer multiple of 2, and two adjacent rows of squares are aligned, or two adjacent rows of squares are staggered. In addition, the battle area is evenly divided into two parts by rows, which a friendly battle area and an opponent battle area, respectively. Users participating in the battle are respectively located on an upper side and a lower side of the battle interface. In the battle preparation phase, the users may only place pieces in the friendly battle area. In some other embodiments, the battle area is evenly divided into two parts by columns, which are a friendly battle area and an opponent battle area, respectively. Users participating in the battle are respectively located on a left side and a right side of the battle interface. A shape of the chess grid may be any one of a square, a rectangle, a circle, and a hexagon. The shape of the chess grid is not limited in the embodiments of this application.

Virtual equipment: in an auto chess game three pieces of virtual equipment (or other pieces of virtual equipment) may be worn on each virtual piece. The virtual equipment may provide the hero with attributes or effects such as attack power, defense power, health points, healing, penetration, and a shield. An auto chess game in the related art typically includes a creeping phase. After defeating a neutral monster, a player obtains virtual equipment dropped by the neutral monster, and picks up the virtual equipment into a backpack. The virtual equipment may alternatively be assembled as individual components, to obtain higher quality virtual equipment.

Chess player: it refers to virtual character played by a player, and is also referred to as a virtual chess player. Each chess player has different special abilities that can help players play a game better.

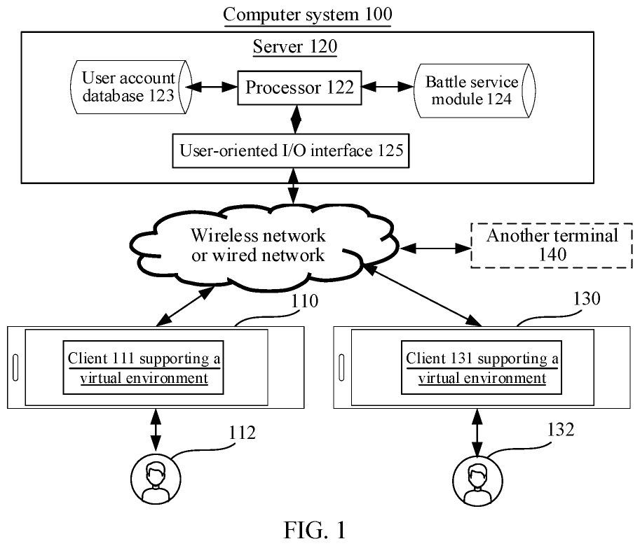

FIG. 1 is a structural block diagram of a computer system according to an exemplary embodiment of this application. A computer system 100 includes: a first terminal 110, a server 120, and a second terminal 130. A client 111 supporting a virtual environment is installed and run on the first terminal 110. The client 111 may be a round-based board game program. When the first terminal runs the client 111, a user interface (UI) of the client 111 is displayed on a screen of the first terminal 110. The client may be a client of an auto chess game. The first terminal 110 is a terminal used by a first user 112. In a battle preparation phase of a match, the first user 112 uses the first terminal 110 to deploy pieces in a battle area of a chessboard. In a battle phase, the first terminal 110 or the server 120 automatically controls the pieces to engage in battle based on attributes, skills, and a layout of the pieces in the battle area. A client 131 supporting a virtual environment is installed and run on the second terminal 130. The client 131 may be a round-based board game program. When the second terminal 130 runs the client 131, a UI of the client 131 is displayed on a screen of the second terminal 130. The client may be a client of an auto chess game. The second terminal 130 is a terminal used by a second user 132. In a battle preparation phase of a match, the second user 132 uses the second terminal 130 to deploy pieces in a battle area of a chessboard. In a battle phase, the second terminal 130 or the server 120 automatically controls the pieces to engage in battle based on attributes, skills, and a layout of the pieces in the battle area.

In an embodiment, the virtual pieces deployed by the first user 112 through the first terminal 110 and the virtual pieces deployed by the second user 132 through the second terminal 130 are located in different battle areas of a same chessboard. Alternatively, the virtual pieces deployed by the first user 112 through the first terminal 110 and the virtual pieces deployed by the second user 132 through the second terminal 130 are located on different chessboards. In an exemplary embodiment, six user accounts jointly participate in a same virtual match of a round-based board game. In each round, the six user accounts are paired up, and two user accounts that are paired together engage in battle on a same chessboard during the current round.

In an embodiment, the client installed on the first terminal 110 is the same as the client installed on the second terminal 130, or the clients installed on the two terminals are clients of a same type on different operating system platforms. The first terminal 110 may refer to one of a plurality of terminals, and the second terminal 130 may refer to another of the plurality of terminals. This embodiment is described by merely using the first terminal 110 and the second terminal 130 as examples. A device type of the first terminal 110 may be the same as or different from a device type of the second terminal 130. The device type includes at least one of a smartphone, a tablet computer, an e-book reader, a Moving Picture Experts Group Audio Layer III (MP3) player, a Moving Picture Experts Group Audio Layer IV (MP4) player, a laptop portable computer, and a desktop computer. The following embodiments are described by using an example in which the terminal includes a smartphone. A person skilled in the art may know that more or fewer terminals may be provided. For example, only one terminal (that is, a user engages in a match against artificial intelligence) may be provided, or six or eight or more terminals may be provided. A quantity and a device type of the terminal are not limited in the embodiments of this application.

FIG. 1 only shows two terminals. However, in different embodiments, a plurality of other terminals 140 may access the server 120. In an embodiment, one or more terminals 140 may be terminals corresponding to a developer. A development and editing platform for a client supporting a virtual environment is installed on the terminal 140, and the developer can edit and update the client on the terminal 140, and transmits an updated client installation package to the server 120 over a wired or wireless network. The first terminal 110 and the second terminal 130 can download the client installation package from the server 120 to update the client. The first terminal 110, the second terminal 130, and the other terminals 140 are connected to the server 120 via a wireless network or a wired network. The server 120 includes at least one of one server, a plurality of servers, a cloud computing platform, and a virtualization center. The server 120 is configured to provide a backend service for the client supporting the virtual environment (a client of the round-based board game/a client of the auto chess game). In an embodiment, the server 120 undertakes primary computing work, and the terminal undertakes secondary computing work. Alternatively, the server 120 undertakes secondary computing work, and the terminal undertakes primary computing work. Alternatively, a distributed computing architecture is used between the server 120 and the terminal for collaborative computing.

In an exemplary example, the server 120 includes a processor 122, a user account database 123, a battle service module 124, and a user-oriented input/output (I/O) interface 125. The processor 122 is configured to load an instruction stored in the server 120, and process data in the user account database 123 and the battle service module 124. The user account database 123 is configured to store data of user accounts used by the first terminal 110, the second terminal 130, and the other terminals 140, such as avatars of the user accounts, nicknames of the user accounts, battle power indexes of the user accounts, and service areas where the user accounts are located. The battle service module 124 is configured to provide a plurality of battle rooms for battles between users. The user-oriented I/O interface 125 is configured to establish communication and exchange data with the first terminal 110 and/or the second terminal 130 over a wireless network or a wired network.

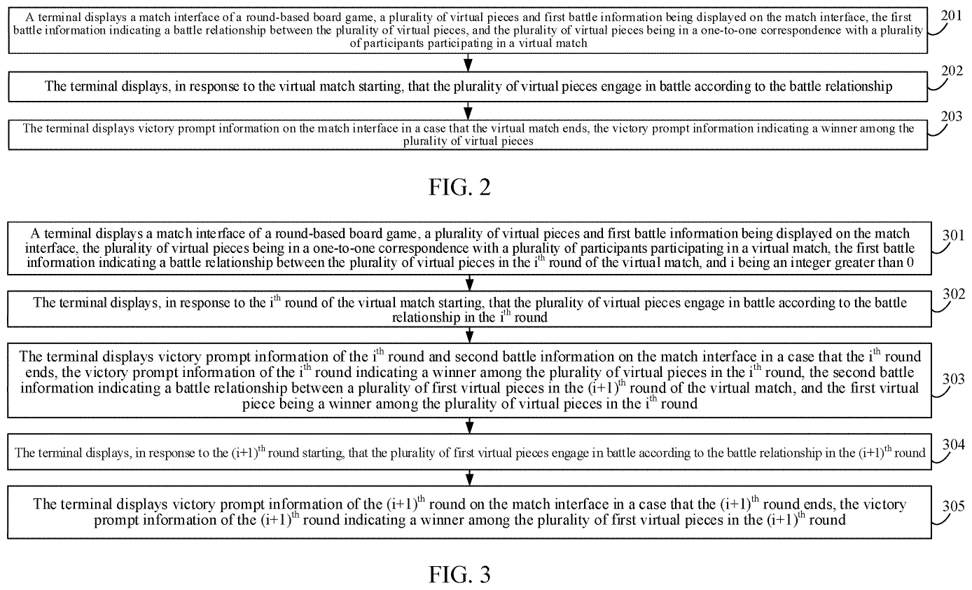

FIG. 2 is a flowchart of a match method according to an embodiment of this application. For example, the method is performed by a terminal. As shown in FIG. 2, the method includes:
201: The terminal displays a match interface of a round-based board game, a plurality of virtual pieces and first battle information being displayed on the match interface, the first battle information indicating a battle relationship between the plurality of virtual pieces, and the plurality of virtual pieces being in a one-to-one correspondence with a plurality of participants participating in a virtual match.

In the embodiments of this application, in the virtual match of the round-based board game, the plurality of participants participating in the virtual match can respectively select one virtual piece, and the plurality of participants participates in a same virtual match through the selected virtual pieces. Before the virtual match starts, the plurality of virtual pieces participating in the same virtual match and the battle relationship specified for the plurality of virtual pieces may be displayed on the match interface. During the virtual match, the virtual pieces can engage in battle according to the specified battle relationship, an image in which the virtual pieces corresponding to the plurality of participants engage in battle is presented, and finally victory prompt information indicating a winner among the plurality of virtual pieces is displayed. This implements a novel match method that allows the virtual pieces corresponding to the plurality of participants to engage in battle in the same virtual match.

The match interface is configured for displaying the virtual pieces participating in the virtual match. The virtual piece can be represented by any image. For example, the virtual piece is an image such as a virtual person or a virtual animal. The first battle information can be represented in any form. For example, the first battle information is represented in the form of an image, or represented in the form of text. A quantity of the plurality of virtual pieces is equal to a quantity of the plurality of participants, and the virtual piece corresponding to each participant is a virtual piece selected by the participant and configured for participating in the virtual match. That is, the virtual piece corresponding to the participant is a virtual piece possessed by the participant. The participant is configured for representing a user, and the plurality of participants are a plurality of users participating in the same virtual match. The terminal is a terminal used by any one of the plurality of participants. The quantity of the plurality of participants is equal to or greater than two. In the embodiments of this application, the virtual pieces corresponding to the plurality of participants participating in the virtual match and the first battle information are displayed on the match interface. In this way, each participant can learn a subsequent match situation of the virtual match.
202: The terminal displays, in response to the virtual match starting, that the plurality of virtual pieces engage in battle according to the battle relationship.

In the embodiments of this application, in response to the virtual match starting, the plurality of virtual pieces participating in the virtual match automatically engage in battle according to the battle relationship indicated by the first battle information. The terminal displays an image in which the plurality of virtual pieces engage in battle. 203: The terminal displays victory prompt information on the match interface when the virtual battle ends, the victory prompt information indicating a winner among the plurality of virtual pieces.

In the embodiments of this application, the end of the virtual match means that the battle among the plurality of virtual pieces participating in the virtual match ends. In this case, the victory prompt information is displayed on the match interface, to indicate the winner among the plurality of virtual pieces. In this way, the plurality of participants can learn a battle result of the current virtual match. The victory prompt information can be represented in any form. For example, the victory prompt information can be represented in the form of text or an image.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

Based on the embodiment shown in FIG. 2, the virtual match in the embodiments of this application includes a plurality of rounds. Virtual pieces and battle information are displayed before each round starts, to prompt a battle relationship between the virtual pieces in the upcoming round, and a winner of a previous round can enter a next round. For details of a specific process, refer to the following embodiments. FIG. 3 is a flowchart of a match method according to an embodiment of this application. For example, the method is performed by a terminal. As shown in FIG. 3, the method includes:
301: The terminal displays a match interface of a round-based board game, a plurality of virtual pieces and first battle information being displayed on the match interface, the plurality of virtual pieces being in a one-to-one correspondence with a plurality of participants participating in a virtual match, the first battle information indicating a battle relationship between the plurality of virtual pieces in the i^{th} round of the virtual match, and i being an integer greater than 0.

In the embodiments of this application, the virtual match includes at least one round. Before any round of the virtual match starts, the plurality of virtual pieces participating in the upcoming round and a battle relationship between the plurality of virtual pieces in the upcoming round are displayed on the match interface. In this way, each participant can learn a battle situation of the upcoming round by viewing the match interface through the terminal.

In an implementation, the virtual match includes a plurality of rounds, and the i^{th} round is any one of the plurality of rounds. During the virtual battle, after any round ends, only a winner of the round among the virtual pieces participating in the round can participate in a next round. When i is equal to 1, the plurality of virtual pieces displayed on the match interface are all virtual pieces participating in the virtual match. When i is greater than 1, the plurality of virtual pieces displayed on the match interface are some of all the virtual pieces participating in the virtual match.

In an implementation, the first battle information includes a plurality of first battle preparation combinations. The first battle preparation combination includes two battle preparation areas and a connection line between the two battle preparation areas. One virtual piece is displayed in each battle preparation area, and the connection line indicates that the virtual pieces in the two connected battle preparation areas have a battle relationship.

In the embodiments of this application, the virtual pieces having the battle relationship are displayed in the form of the battle preparation combination in the first battle information, two battle preparation areas included in each battle preparation combination are connected via a line, and virtual pieces located in the preparation areas included in a same battle preparation combination have the battle relationship. In this way, the plurality of virtual pieces participating in the virtual match are paired up for battling, and the first battle information can clearly present the battle relationship between the plurality of virtual pieces. This ensures a display effect of the first battle information. A quantity of the plurality of virtual pieces is twice a quantity of the plurality of first battle preparation combinations. That is, a quantity of battle preparation areas in the first battle information is equal to the quantity of the plurality of virtual pieces.

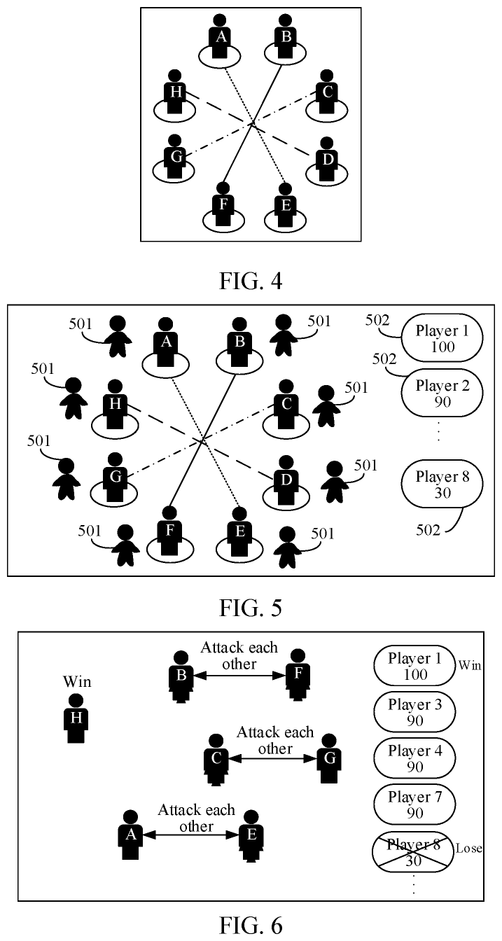

For example, the match interface is shown in FIG. 4. Eight virtual pieces are displayed on the match interface, which are a virtual piece A, a virtual piece B, a virtual piece C, a virtual piece D, a virtual piece E, a virtual piece F, a virtual piece G, and a virtual piece H, respectively. Circular areas occupied by the eight virtual pieces are the battle preparation areas, and two circular areas connected via a same line form one first battle preparation combination. In this case, the eight battle preparation areas are paired up to form four first battle preparation combinations. The eight circular areas and the four lines form the first battle information.

In an embodiment, the virtual pieces corresponding to the plurality of participants are randomly allocated to candidate areas included in the first battle information, that is, the plurality of virtual pieces are randomly paired up. Eight virtual pieces are used as an example. The first battle information includes four first battle preparation combinations, namely, a total of eight battle preparation areas, and the eight virtual pieces are randomly allocated to the eight battle preparation areas, with exactly one virtual piece in each battle preparation area. Two virtual pieces located in a same first battle preparation combination have a battle relationship. In this way, the eight virtual pieces are randomly paired up.

In an embodiment, at least one of a virtual chess player corresponding to each virtual piece and participant information corresponding to each virtual piece are further display on the match interface. The virtual chess player refers to a virtual character played by a player. In a subsequent battle process, an image in which the virtual chess player controls the virtual piece to battle against another virtual piece can be presented. The virtual chess player corresponding to the virtual piece is a virtual chess player controlled by a participant corresponding to the virtual piece. The participant information corresponding to the virtual piece is configured to describing the participant. For example, the participant information includes a participant identifier, health points of the participant in the virtual match, and the like. The health points of the participant in the virtual match are also equivalent to health points of the virtual piece corresponding to the participant. When the health points drop to 0, it indicates that the participant fails and is eliminated from the virtual match. In the embodiments of this application, the first battle information further includes the virtual chess player corresponding to the virtual piece or the participant information corresponding to the virtual piece. This enriches information included in the match interface and ensures a display effect of the match interface.

For example, the match interface is shown in FIG. 5. Eight virtual pieces are displayed on the match interface, which are a virtual piece A, a virtual piece B, a virtual piece C, a virtual piece D, a virtual piece E, a virtual piece F, a virtual piece G, and a virtual piece H, respectively. Circular areas occupied by the eight virtual pieces are the preparation areas. The first battle information includes the eight circular areas and four lines. A corresponding virtual chess player 501 is displayed near each virtual piece. Eight pieces of participant information 502 are displayed on the right side of the match interface. A participant identifier, such as “player 1” or “player 2”, is displayed in each piece of participant information 502. Health points of participants in the virtual match are displayed below the participant identifiers in the participant information 502. For example, the health points are equal to 100, 90, 30, or the like.
302: The terminal displays, in response to the i^{th} round of the virtual match starting, that the plurality of virtual pieces engage in battle according to the battle relationship in the i^{th} round.

In the embodiments of this application, after the i^{th} round of the virtual match starts, it is displayed that the plurality of virtual pieces engage in battle according to the battle relationship in the i^{th} round. In this way, a battle image of the plurality of virtual pieces is presented, and the participant can view the battle image through the terminal, to learn a battle situation of the plurality of virtual pieces. Then, when the i^{th} round ends, victory prompt information of the i^{th} round can be displayed, to indicate which virtual piece wins in the i^{th} round. In this way, the participant can learn a battle result of the i^{th} round. This ensures a display effect and improves user experience.

In an implementation, operation 302 includes: displaying, in response to the i^{th} round of the virtual match starting, that the plurality of virtual pieces engage in battle according to the battle relationship in the i^{th} round on the match interface. In the embodiments of this application, after the i^{th} round of the virtual match starts, the battle image of the plurality of virtual pieces can be directly displayed on the match interface. This ensures a display effect of the battle image.

In an implementation, operation 302 includes: switching display from the match interface to a battle interface in response to the i^{th} round of the virtual match, and displaying that the plurality of virtual pieces engage in battle according to the battle relationship in the i^{th} round on the battle interface. In the embodiments of this application, the battle interface is configured for displaying an image in which the virtual pieces engage in battle, and the match interface is configured for displaying only the virtual pieces participating in the virtual match and battle information. Therefore, when the i^{th} round of the virtual match starts, display is switched from the match interface to the battle interface. In this way, an image in which the plurality of virtual pieces engage in battle according to the battle relationship in the i^{th} round on the battle interface. This ensures an image display effect. In an embodiment, a virtual chessboard is displayed on the battle interface, and the plurality of virtual pieces engage in battle on a same virtual chessboard according to the battle relationship in the i^{th} round.

In an implementation, a manner of starting the i^{th} round includes: displaying, when a display duration of displaying the plurality of virtual pieces and the first battle information on the match interface reaches a duration threshold, that the plurality of virtual pieces engage in battle according to the battle relationship in the i^{th} round. In the embodiments of this application, the plurality of virtual pieces and the first battle information are simultaneously displayed on the match interface. In this case, when the display duration reaches the duration threshold, which is equivalent to receiving a start instruction for the i^{th} round of the virtual match, the i^{th} round is entered, and an image in which the plurality of virtual pieces engage in battle according to the battle relationship in the i^{th} round is displayed. This implements an automatic battle method. In this process, users do not need to perform complex operations. This ensures convenience of battle between the virtual pieces, and improves human-computer interaction efficiency.

In an implementation, the manner of starting the i^{th} round includes: further displaying a battle participation option on the match interface when the plurality of virtual pieces and the first battle information are displayed on the match interface, and displaying, in response to receiving battle participation instructions from the plurality of participants, the plurality of virtual pieces engage in battle according to the battle relationship in the i^{th} round. In the embodiments of this application, a terminal used by each participant displays the battle participation option on the match interface, and each participant can trigger the battle participation option through the respective terminal. When any participant triggers the battle participation option through the terminal, it indicates that the participant confirms to enter the upcoming i^{th} round. When the plurality of participants can trigger the battle participation option through the respective terminals, it indicates that the plurality of participants confirm to enter the upcoming i^{th} round. In this case, it is equivalent to receiving battle participation instructions from the plurality of participants, the i^{th} round is entered, and an image in which the plurality of virtual pieces engage in battle according to the battle relationship in the i^{th} round is displayed. In this way, the plurality of participants participating in the same virtual match jointly determine whether to enter a next round. This implements a novel interaction method that ensures an interactive effect among the plurality of participants.

The battle participation option is any type of option. For example, the battle participation option is a button or a slide bar. For example, when displaying the match interface, terminals used by eight participants all display the battle participation option on the match interface. The i^{th} round is entered only when the eight participants click/tap the battle participation option on the match interface through the terminals.

In an embodiment, the terminal transmits a battle participation request to a server in response to a trigger operation for the battle participation option. The server transmits, in response to receiving the battle participation requests transmitted by the terminals corresponding to the plurality of participants, the battle participation instruction to the terminals corresponding to the plurality of participants. The terminal corresponding to each participant receives the battle participation instruction, and displays, in response to the battle participation instruction, that the plurality of virtual pieces engage in battle according to the battle relationship in the i^{th} round. The battle participation request indicates that the virtual piece corresponding to the terminal requests to participate in a next round. In an embodiment, the battle participation request carries a participant identifier logged in on the terminal and a virtual match identifier.

In the embodiments of this application, the server is configured to provide a service for the round-based board game. The server can receive the battle participation request transmitted by the terminal. Which participants have confirmed to participate in the next round can be learned through the battle participation request. When the battle participation requests transmitted by the terminals corresponding to the plurality of participants are received, it indicates that the plurality of participants have confirmed to participate in the next round. In this case, the server transmits the battle participation instruction to the terminals corresponding to the participants. In this way, the terminals can enter the next round and display a battle image of the next round. This ensures accuracy of image display.

In an implementation, the first battle information includes a plurality of first battle preparation combinations. The first battle preparation combination includes two battle preparation areas and a connection line between the two battle preparation areas. One virtual piece is displayed in each battle preparation area. In this case, the process of displaying that the plurality of virtual pieces engage in battle includes: displaying, in response to the i^{th} round of the virtual match, that two virtual pieces corresponding to a same first battle preparation combination engage in battle, battles between virtual pieces corresponding to different first battle preparation combinations not interfering with each other; and displaying, in response to the battle between two virtual pieces corresponding to any first battle preparation combination ends, prompt information indicating a winner in the two virtual pieces, and canceling display of a loser in the two virtual pieces.

In the embodiments of this application, the first battle information indicates a pairwise battle relationship between the plurality of virtual pieces in the i^{th} round of the virtual match. After the i^{th} round of the virtual match starts, it is displayed in a same image that the plurality of virtual pieces engage in pairwise battles, and battles between virtual pieces corresponding to different first battle preparation combinations do not interfere with each other. In addition, because battles between virtual pieces corresponding to the plurality of first battle preparation combinations end at different time points, provided that the battle between the two virtual pieces corresponding to any first battle preparation combination ends, prompt information indicates a winner in the two virtual pieces is displayed, and display of a loser in the two virtual pieces is canceled, to reflect that the battle between the two virtual pieces corresponding to the first battle preparation combination ends and the virtual pieces corresponding to the remaining first battle preparation combinations continue to battle. This can enrich displayed information and improve a display effect in the process in which the plurality of virtual pieces engage in battle according to the battle relationship in the i^{th} round.

For example, it is displayed on the match interface that the plurality of virtual pieces engage in battle according to the battle relationship in the i^{th} round. Before the i^{th} round starts, eight virtual pieces are displayed on the match interface, which are a virtual piece A, a virtual piece B, a virtual piece C, a virtual piece D, a virtual piece E, a virtual piece F, a virtual piece G, and a virtual piece H, respectively. The match interface after the i^{th} round starts is shown in FIG. 6. It is displayed on the match interface that the virtual piece B and the virtual piece F attack each other, the virtual piece C and the virtual piece G attack each other, the virtual piece A and the virtual piece E attack each other, and a battle between the virtual piece D and the virtual piece H ends. After the battle between the virtual piece D and the virtual piece H ends, the virtual piece H wins the battle, and the virtual piece D loses the battle. In this case, display of the virtual piece D on the battle interface is canceled, and prompt information “Win” is displayed above the virtual piece H. In addition, a plurality of pieces of participant information are displayed on the right side of the match interface, the prompt information “Win” is displayed on the right side of participant information “Player 1” corresponding to the virtual piece H, and prompt information “Lose” is displayed on the right side of participant information “Player 8” corresponding to the virtual piece D.
303: The terminal displays victory prompt information of the i^{th} round and second battle information on the match interface when the i^{th} round ends, the victory prompt information of the i^{th} round indicating a winner among the plurality of virtual pieces in the i^{th} round, the second battle information indicating a battle relationship between a plurality of first virtual pieces in the (i+1)^{th} round of the virtual match, and the first virtual piece being a winner among the plurality of virtual pieces in the i^{th} round.

In the embodiments of this application, when the i^{th} round ends, not only the victory prompt information of the i^{th} round is displayed on the match interface, but also the second battle information is displayed on the match interface, to indicate which virtual piece wins in the i^{th} round and the battle relationship between the virtual pieces that win in the i^{th} round in the (i+1)^{th} round. Then, the (i+1)^{th} round is conducted. When the (i+1)^{th} round ends, victory prompt information of the (i+1)^{th} round can be displayed. That is, battles in a plurality of rounds are automatically conducted during the virtual match. In addition, battle information of an upcoming round is displayed before each round starts, and a battle result is displayed after the rounds ends. This enriches displayed content, to allow the participants to learn battle situations and battle results of the rounds, ensures a display effect, and improves user experience. Furthermore, a user operation is not required in this process. This improves human-computer interaction efficiency. The victory prompt information is represented in any form. For example, the victory prompt information is represented in the form of text. A quantity of the plurality of first virtual pieces is less than a quantity of the plurality of virtual pieces.

For example, the quantity of virtual pieces participating in the i^{th} round is equal to 8. After the i^{th} round starts, the eight virtual pieces engage in pairwise battles according to the battle relationship in the i^{th} round. When the i^{th} round ends, winners among the plurality of virtual pieces in the i^{th} round include four virtual pieces. That is, four first virtual pieces are determined.

In an implementation, the end of the i^{th} round refers to the end of all battles between the plurality of virtual pieces participating in the i^{th} round. For example, the quantity of virtual pieces participating in the i^{th} round is equal to 8. After the i^{th} round starts, the eight virtual pieces engage in pairwise battles according to the battle relationship in the i^{th} round. That is, the terminal can display an image in which four groups of virtual pieces engage in battle, with each group including two virtual pieces. When at least one group has not yet finished the battle currently, that is, when virtual pieces still engage in battle, it indicates that the i^{th} round is still in progress. When all the four groups of virtual pieces finish the battles, that is, when all the eight virtual pieces have finished the battles, it indicates that the i^{th} round ends.

In an implementation, when the i^{th} round ends, the plurality of first virtual pieces, the victory prompt information of the i^{th} round, and the second battle information are displayed on the match interface. In the embodiments of this application, when the i^{th} round ends, only the virtual piece winning the battle in the i^{th} round, the victory prompt information of the i^{th} round, and the second battle information are displayed on the match interface, and the virtual piece losing the battle in the i^{th} round is no longer displayed. In this way, the participant can clearly learn a battle situation of a next round by viewing content displayed on the match interface. This simplifies content displayed on the match interface, and ensures a display effect of the match interface.

In an embodiment, it is displayed on the battle interface that the plurality of virtual pieces engage in battle according to the battle relationship in the i^{th} round. In this case, operation 303 includes: The terminal switches display from the battle interface to the match interface when the i^{th} round ends. The plurality of first virtual pieces, the victory prompt information of the i^{th} round, and the second battle information are displayed on the match interface. In the embodiments of this application, when the i^{th} round ends, display is switched from the battle interface to the match interface, to display a match result of the i^{th} round and a match situation of a next round on the match interface. This ensures a display effect.

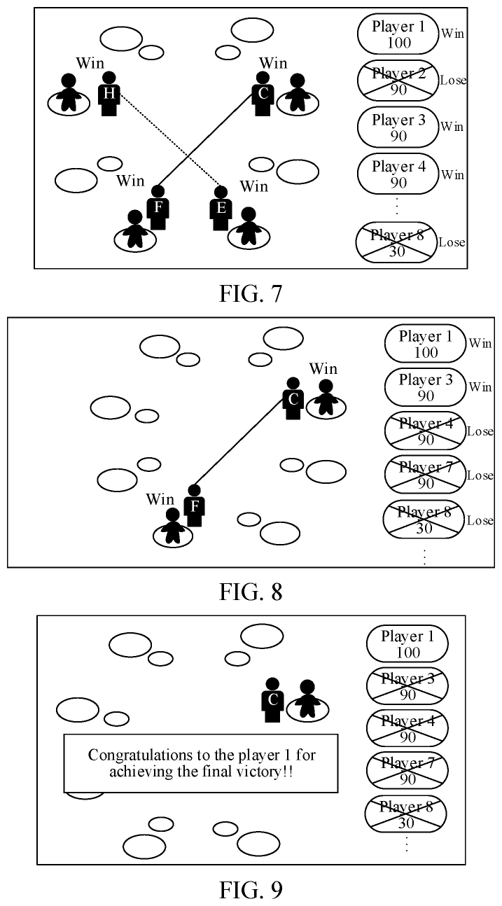

In an implementation, a manner of displaying the victory prompt information of the i^{th} round on the match interface includes: displaying, if the victory prompt information includes content indicating a victory, the victory prompt information near a position of each first virtual piece when the plurality of first virtual pieces are displayed on the match interface; or displaying the victory prompt information at any position in the match interface if the victory prompt information includes identifiers of the plurality of first virtual pieces or participant identifiers corresponding to the plurality of first virtual pieces. For example, the victory prompt information is “Win”, and a quantity of first virtual pieces winning the battles in the i^{th} round is equal to 4. The match interface after the i^{th} round ends is shown in FIG. 7. “Win” is displayed near each first virtual piece, to indicate that the four first virtual pieces win in the i^{th} round, and four virtual pieces losing the battles in the i^{th} round are no longer displayed. In addition, when a plurality of pieces of participant information are displayed on the match interface, a failure identifier is displayed on the participant information corresponding to the failing participant, as shown by a cross in FIG. 7, to prompt that the participant fails in the virtual match. For another example, the victory prompt information is “Congratulations to the virtual piece C, the virtual piece E, the virtual piece F, and the virtual piece H for winning in the i^{th} round”, or is “Congratulations to the player 3, the player 5, the player 6, and the player 8 for winning in the i^{th} round”.

The embodiments of this application are described by using an example in which the plurality of first virtual pieces win the battles in the i^{th} round. In another embodiment, there is only one winner among the plurality of virtual pieces in the i^{th} round. In this case, no other rounds are conducted after the i^{th} round, only the virtual piece winning the battle in the i^{th} round and the victory prompt information of the i^{th} round are displayed on the match interface, and the second battle information is no longer displayed.

The embodiments of this application are described by using an example in which a current round of the virtual match is the i^{th} round. In another embodiment, operation 302 and operation 303 do not need to be performed, and instead, another manner is used. The first battle information indicates the battle relationship between the plurality of virtual pieces. In response to the virtual match starting, it is displayed that the plurality of virtual pieces engage in battle according to the battle relationship. When the virtual match ends, the victory prompt information is displayed on the match interface. The victory prompt information indicates the winner among the plurality of virtual pieces.
304: The terminal displays, in response to the (i+1)^{th} round starting, that the plurality of first virtual pieces engage in battle according to the battle relationship in the (i+1)^{th} round.

In the embodiments of this application, during the virtual match, when a new round of the virtual match starts, health points of each virtual piece reach maximum health points of the virtual piece. That is, during the plurality of rounds of the virtual match, a virtual piece winning in a previous round engages in battle in a next round. During the battle in the previous round, health points of the virtual piece are deducted, which may affect a battle result of the next round. Therefore, when the next round starts, the health points of each virtual piece reach the maximum health points of the virtual piece. In this way, each virtual piece is in a full health state and enters the next round for the battle. This ensures fairness of the game.

Operation 304 is similar to operation 302. Details are not described herein again.
305: The terminal displays victory prompt information of the (i+1)^{th} round on the match interface when the (i+1)^{th} round ends, the victory prompt information of the (i+1)^{th} round indicating a winner among the plurality of first virtual pieces in the (i+1)^{th} round.

Operation 305 is similar to operation 303. Details are not described herein again.

In the embodiments of this application are described by using only the i^{th} round and the (i+1)^{th} round of the virtual match as an example. In another embodiment, there is only one winner among the plurality of first virtual pieces in the (i+1)^{th} round, after the (i+1)^{th} round ends, a next round is not conducted, and the victory prompt information of the (i+1)^{th} round can further indicate that the winner among the plurality of first virtual pieces in the (i+1)^{th} round is a final winner of the virtual match. When there are a plurality of winner among the plurality of first virtual pieces in the (i+1)^{th} round, after the (i+1)^{th} round ends, the next round is further conducted. When the (i+1)^{th} round ends, battle information corresponding to the (i+2)^{th} round of the virtual match is further displayed on the match interface. The battle information indicates a battle relationship between the winners of the (i+1)^{th} round in the (i+2)^{th} round. Then, the (i+2)^{th} round is conducted according to operation 304 and operation 305 until the k^{th} round ends and there is one winner of the k^{th} round, where k is an integer greater than 2.

For example, eight participants participate in the virtual match. In this case, a quantity of virtual pieces participating in the 1^{st} round of the virtual match is equal to 8. As shown in FIG. 5, the eight virtual pieces and battle information indicating a battle relationship between the eight virtual pieces in the 1^{st} round are displayed on the match interface. After the 1^{st} round of the virtual match starts, it is displayed that four groups of virtual pieces engage in battle. When the 1^{st} round ends, as shown in FIG. 7, four virtual pieces winning the battles in the 1^{st} round, battle information indicating a battle relationship between the four virtual pieces in the 2^{nd} round, and victory prompt information of the 1^{st} round are displayed on the match interface. The victory prompt information of the 1^{st} round indicates the virtual pieces winning in the 1^{st} round. After the 2^{nd} round of the virtual match starts, it is displayed that two groups of virtual pieces engage in battle. When the 2^{nd} round ends, as shown in FIG. 8, two virtual pieces winning the battles in the 2^{nd} round, battle information indicating a battle relationship between the two virtual pieces in the 3^{rd} round, and victory prompt information of the 2^{nd} round are displayed on the match interface. The victory prompt information of the 2^{nd} round indicates the virtual pieces winning in the 2^{nd} round. After the 3^{rd} round of the virtual match starts, it is displayed that the two virtual pieces winning the battles in the 2^{nd} round engage in battle. When the 3^{rd} round ends, as shown in FIG. 9, one virtual piece winning the battle in the 3^{rd} round and victory prompt information of the 3^{rd} round are displayed on the match interface. The victory prompt information of the 3^{rd} round is “Congratulations to the player 1 for achieving the final victory! !”, and the victory prompt information of the 3^{rd} round indicates that the virtual piece winning in the 3^{rd} round is a virtual piece corresponding to the player 1 and the virtual piece is a virtual piece finally winning the virtual match.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

Based on the embodiment shown in FIG. 3, in the embodiments of this application, when the quantity of virtual pieces participating in any round of the virtual match is an odd number, one piece can be selected from the virtual pieces participating in a current round to no longer engage in battle in the current round and instead directly advance to a next round. For details of a specific process, refer to the following embodiments.

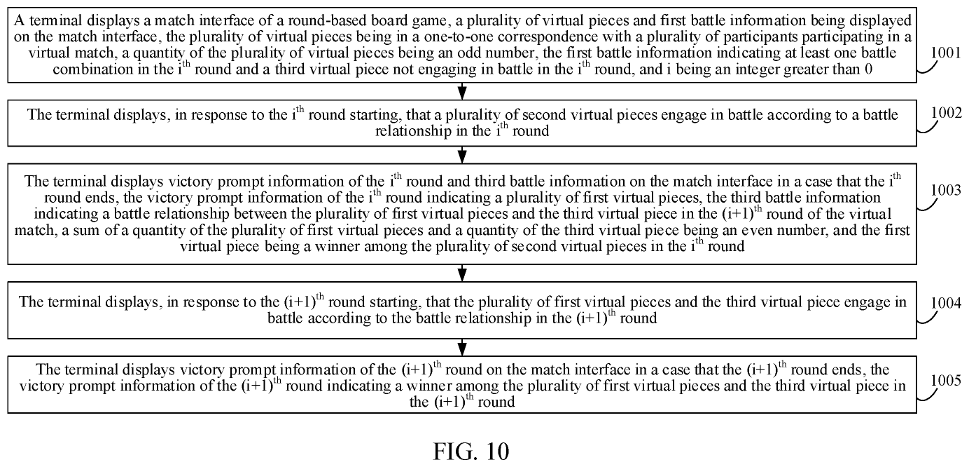

FIG. 10 is a flowchart of a match method according to an embodiment of this application. For example, the method is performed by a terminal. As shown in FIG. 10, the method includes:
1001: The terminal displays a match interface of a round-based board game, a plurality of virtual pieces and first battle information being displayed on the match interface, the plurality of virtual pieces being in a one-to-one correspondence with a plurality of participants participating in a virtual match, a quantity of the plurality of virtual pieces being an odd number, the first battle information indicating at least one battle combination in the i^{th} round and a third virtual piece not engaging in battle in the i^{th} round, and i being an integer greater than 0.

The plurality of virtual pieces includes a plurality of second virtual pieces and a third virtual pieces, the third virtual piece is any one of the plurality of virtual pieces, and the second virtual pieces are virtual pieces other than the third virtual piece in the plurality of virtual pieces. The quantity of the plurality of virtual pieces is an odd number. In this case, a quantity of the plurality of second virtual pieces is an even number. This indicates that the plurality of second virtual pieces can be paired up for battling in the i^{th} round. The battle combination includes any two second virtual pieces having a battle relationship, and second virtual pieces included in different battle combinations are completely different. For example, seven virtual pieces are displayed on the match interface. In this case, in addition to the third virtual piece, six second virtual pieces are displayed on the match interface, the first battle information indicates three battle combinations in the i^{th} round, a first battle combination includes a second virtual piece 1 and a second virtual piece 2, a second battle combination includes a second virtual piece 3 and a second virtual piece 4, and a third battle combination includes a second virtual piece 5 and a second virtual piece 6. That is, the first battle information indicates that in the i^{th} round, the third virtual piece in the seven virtual pieces does not engage in battle, the second virtual piece 1 and the second virtual piece 2 in the seven virtual pieces engage in battle, the second virtual piece 3 and the second virtual piece 4 in the seven virtual pieces engage in battle, and the second virtual piece 5 and the second virtual piece 6 in the seven virtual pieces engage in battle.

In an implementation, a process of determining the third virtual piece from the plurality of virtual pieces includes: randomly determining one virtual piece from the plurality of virtual pieces, determining the randomly determined virtual piece as the third virtual piece, and determining virtual pieces other than the third virtual piece in the plurality of virtual pieces as the second virtual pieces. In the embodiments of this application, when the quantity of the plurality of virtual pieces is an odd number, it is randomly determined from the plurality of virtual pieces that one virtual piece does not participate in an upcoming round but directly participates in the (i+1)^{th} round as a winner of the i^{th} round. This ensures that an image in which the virtual pieces are paired up for battling in each round can be displayed, ensures a display effect of a battle image, and can also ensure fairness of the game.

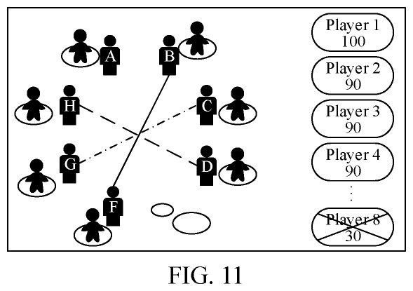

For example, the match interface is shown in FIG. 11. Seven virtual pieces are displayed on the match interface, which are a virtual piece A, a virtual piece B, a virtual piece C, a virtual piece D, a virtual piece F, a virtual piece G, and a virtual piece H, respectively. It is randomly determined from the seven virtual pieces that the virtual pieces A does not engage in battle in the i^{th} round, and the remaining six virtual pieces are paired up.

Operation 1001 is similar to operation 301. Details are not described herein again. The embodiments of this application are described by using an example in which the quantity of the plurality of virtual pieces is an odd number. In another embodiment, the first battle information indicates a battle relationship between the plurality of virtual pieces in the i^{th} round of the virtual match.
1002: The terminal displays, in response to the i^{th} round starting, that a plurality of second virtual pieces engage in battle according to a battle relationship in the i^{th} round.

In the embodiment of this application, the quantity of the virtual pieces displayed on the match interface is an odd number, that is, a quantity of the virtual pieces currently participating in the virtual match is an odd number. In this case, when the plurality of virtual pieces are paired up, a virtual piece cannot be combined with another virtual piece. The virtual piece that cannot be combined with another virtual piece does not participate in an upcoming round. This ensures that when a subsequent round starts, an image in which the plurality of virtual pieces are paired up for battling can be displayed, and the virtual piece that cannot be combined with another virtual piece is no longer displayed, ensures a display effect of a battle image, and can also ensure a battle effect.

Operation 1002 is similar to operation 302. Details are not described herein again. The embodiments of this application are described by using an example in which the quantity of the plurality of virtual pieces displayed on the match interface is an odd number. In another embodiment, operation 1002 does not need to be performed, and instead, the process of displaying, in response to the i^{th} round starting, that the plurality of virtual pieces engage in battle according to the battle relationship in the i^{th} round is implemented in another manner.
1003: The terminal displays victory prompt information of the i^{th} round and third battle information on the match interface when the i^{th} round ends, the victory prompt information of the i^{th} round indicating a plurality of first virtual pieces, the third battle information indicating a battle relationship between the plurality of first virtual pieces and the third virtual piece in the (i+1)^{th} round of the virtual match, a sum of a quantity of the plurality of first virtual pieces and a quantity of the third virtual piece being an even number, and the first virtual piece being a winner among the plurality of second virtual pieces in the i^{th} round.

In the embodiments of this application, the plurality of first virtual pieces are the winners among the plurality of second virtual pieces in the i^{th} round. When the i^{th} round ends, the plurality of first virtual pieces and the third virtual piece jointly participate in the (i+1)^{th} round. In addition, when the sum of the quantity of the plurality of first virtual pieces and the quantity of the third virtual piece is an even number, it indicates that the plurality of first virtual pieces and the third virtual piece can be paired up for battling in the (i+1)^{th} round. Furthermore, the third battle information indicates the battle relationship between the plurality of first virtual pieces and the third virtual piece in the (i+1)^{th} round of the virtual match. Subsequently, when the (i+1)^{th} round starts, the plurality of first virtual pieces and the third virtual piece can engage in battle according to the battle relationship in the (i+1)^{th} round of the virtual match. When the (i+1)^{th} round ends, victory prompt information of the (i+1)^{th} round can be displayed. That is, battles in a plurality of rounds are automatically conducted during the virtual match. In addition, battle information of an upcoming round is displayed before each round starts, and a battle result is displayed after the round ends. This enriches displayed content, allows the participants to learn battle situations and battle results of rounds, ensures a display effect and improves user experience. In addition, a user operation is not required in this process. This improves human-computer interaction efficiency. The victory prompt information of the i^{th} round indicates the winner among the plurality of second virtual pieces in the i^{th} round, that is, indicates that the plurality of first virtual pieces win the battles in the i^{th} round. For example, seven virtual pieces are displayed on the match interface. In this case, in addition to the third virtual piece, six second virtual pieces are displayed on the match interface. According to operation 1002 and operation 1003, when the i^{th} round ends, winners among the six second virtual pieces in the i^{th} round are three first virtual pieces, and a sum of a quantity of the three first virtual pieces and the quantity of the third virtual piece is equal to 4. That is, the sum of the quantity of the plurality of first virtual pieces and the quantity of the third virtual piece is an even number.

In the embodiments of this application, in one game of the round-based board game, a quantity of participants participating in a same game is an odd number. Alternatively, the quantity of participants participating in the same game is an even number. However, during the game, a participant who loses the battle may be eliminated. As a result, the quantity of participants during the game becomes an odd number. That is, the quantity of virtual pieces participating in the virtual match may become an odd number.

For example, one game of the round-based board game includes a plurality of stages. Each stage includes a plurality of matches. A last match in each stage is an elite virtual match, and remaining matches are ordinary virtual matches. In the ordinary virtual match, players need to deploy virtual pieces on a virtual chessboard. In this way, when the ordinary virtual match starts, the plurality of players are randomly paired up, and the virtual pieces deployed by both parties that engage in battle on the virtual chessboard are automatically engage in battle. In the elite virtual match, each player only needs to designate one virtual piece for battling, and then the virtual pieces designated by the players engage in battle according to the match method provided in the embodiments of this application. When a current game starts, health points of virtual chess players controlled by the plurality of participants participating in the current game are the same, for example, all are 100. During the current game, health points of a virtual chess player controlled by a participant that is among the plurality of participants and that loses the battle are deducted. When health points of a virtual chess player drop to 0, a participant corresponding to the virtual chess player is eliminated. Therefore, there may be a case where a quantity of players participating in the match is an odd number. In this case, one random virtual piece receives a bye in the current round and directly advances to a next round. That is, the third virtual piece receives a bye in the i^{th} round and directly advances to the (i+1)^{th} round, and only the winner among the plurality of second virtual pieces in the i^{th} round can advance to the (i+1)^{th} round.

In an implementation, when the i^{th} round ends, the plurality of first virtual pieces, the third virtual piece, the victory prompt information of the i^{th} round, and the third battle information are displayed on the match interface. In the embodiments of this application, the match interface is configured for displaying the virtual pieces that participate in an upcoming round, and the virtual piece winning the battle in the i^{th} round and the third virtual piece both participate in the upcoming round. When the i^{th} round ends, the virtual piece winning the battle in the i^{th} round, the third virtual piece, the victory prompt information, and the third battle information of the i^{th} round are displayed on the match interface, and the virtual piece losing the battle in the i^{th} round is no longer displayed. In this way, the participant can clearly learn a battle situation of a next round by viewing content displayed on the match interface. This simplifies content displayed on the match interface, and ensures a display effect of the match interface. Operation 1003 is similar to operation 303. Details are not described herein again.
1004: The terminal displays, in response to the (i+1)^{th} round starting, that the plurality of first virtual pieces and the third virtual piece engage in battle according to the battle relationship in the (i+1)^{th} round.

Operation 1004 is similar to operation 302. Details are not described herein again.
1005: The terminal displays victory prompt information of the (i+1)^{th} round on the match interface when the (i+1)^{th} round ends, the victory prompt information of the (i+1)^{th} round indicating a winner among the plurality of first virtual pieces and the third virtual piece in the (i+1)^{th} round.

Operation 1005 is similar to operation 305. Details are not described herein again.

The embodiments of this application are described by using an example in which the sum of the quantity of the plurality of first virtual pieces and the quantity of the third virtual piece is an even number. In another embodiment, when the sum of the quantity of the plurality of first virtual pieces and the quantity of the third virtual piece is an odd number, operation 1003 to operation 1005 do not need to be performed, and a next round is conducted in another manner.

In an implementation, the sum of the quantity of the plurality of first virtual pieces and the quantity of the third virtual piece is an odd number, and after operation 1002, the method further includes: The terminal displays victory prompt information of the i^{th} round and fourth battle information on the match interface when the i^{th} round ends, the victory prompt information of the i^{th} round indicating the plurality of first virtual pieces, the fourth battle information indicating a battle relationship between a plurality of eighth virtual pieces in the (i+1)^{th} round of the virtual battle and a ninth virtual piece not engaging in battle in the (i+1)^{th} round; the terminal displays, in response to the (i+1)^{th} round, that the plurality of eighth virtual pieces engage in battle according to the battle relationship in the (i+1)^{th} round; and the terminal displays, when the (i+1)^{th} round ends, victory prompt information of the (i+1)^{th} round on the match interface if a sum of a quantity of winners among the plurality of eighth virtual pieces in the (i+1)^{th} round and a quantity of the ninth virtual piece is an even number, the victory prompt information of the (i+1)^{th} round indicating the winner among the plurality of eighth virtual pieces in the (i+1)^{th} round. The first virtual piece is the winner among the plurality of second virtual pieces in the i^{th} round. The ninth virtual piece is any one of the plurality of first virtual pieces and the third virtual piece, and the eighth virtual piece is a virtual piece among the plurality of first virtual pieces and the third virtual piece other than the ninth virtual piece. In the embodiments of this application, when the sum of the quantity of the plurality of first virtual pieces and the quantity of the third virtual piece is an odd number, the next round is conducted according to operation 1001 and operation 1002. That is, the fourth battle information indicates that the ninth virtual piece does not participate in the (i+1)^{th} round but participates in the (i+2)^{th} round, and the plurality of eighth virtual pieces participate in the (i+1)^{th} round, and further indicates the battle relationship between the plurality of eighth virtual pieces in the (i+1)^{th} round of the virtual match. In this way, it is ensured that when a subsequent round starts, an image in which the plurality of eighth virtual pieces are paired up for battling can be displayed, and a virtual piece that cannot be combined with another virtual piece is no longer displayed. This ensures a display effect of a battle image.

The foregoing process of conducting the (i+1)^{th} round is similar to operation 1001 to operation 1003, and details are not described herein again.

In addition, after the (i+1)^{th} round ends, when the sum of quantity of winners among the plurality of eighth virtual pieces in the (i+1)^{th} round of the virtual match and the quantity of the ninth virtual piece is an even number, the next round is conducted according to operation 1003 to operation 1005. When the sum of quantity of the plurality of eighth virtual pieces in the (i+1)^{th} round of the virtual battle and the quantity of the ninth virtual piece is an odd number, the next round is conducted according to operation 1001 to operation 1003 until the k^{th} round ends and there is one winner of the k^{th} round, where k is an integer greater than 2.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

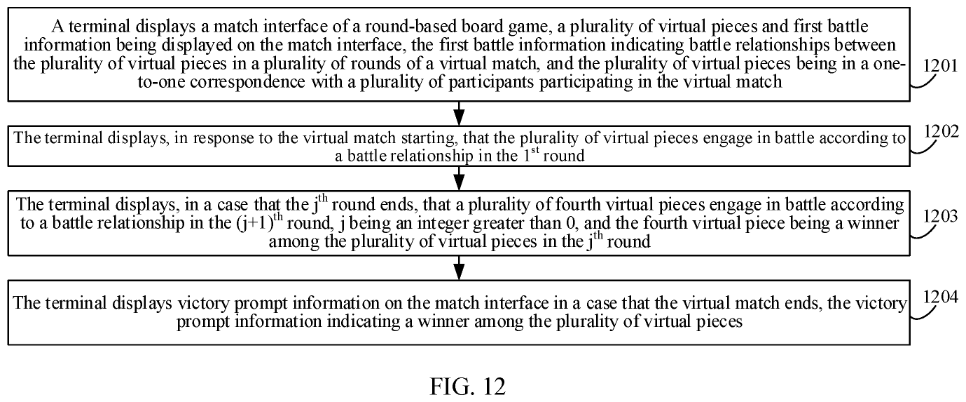

Based on the embodiment shown in FIG. 2, in the embodiments of this application, before the virtual match starts, battle relationships between the plurality of virtual pieces in a plurality of rounds of the virtual match are displayed, and after the virtual match starts, the plurality of virtual pieces automatically engage in battle until the virtual match ends. For details of a specific process, refer to the following embodiments. FIG. 12 is a flowchart of a match method according to an embodiment of this application. For example, the method is performed by a terminal. As shown in FIG. 12, the method includes:
1201: The terminal displays a match interface of a round-based board game, a plurality of virtual pieces and first battle information being displayed on the match interface, the first battle information indicating battle relationships between the plurality of virtual pieces in a plurality of rounds of a virtual match, and the plurality of virtual pieces being in a one-to-one correspondence with a plurality of participants participating in the virtual match.

In the embodiments of this application, the virtual match includes the plurality of rounds. Before the virtual match starts, the plurality of virtual pieces participating in the same virtual match and the battle relationships between the plurality of virtual pieces in the plurality of rounds of the virtual match are displayed on the match interface. In this way, the participants can learn a battle situation of the plurality of virtual pieces in the virtual match by viewing the match interface through the terminal. Furthermore, after the virtual match starts, the plurality of virtual pieces automatically engage in battle until the virtual match ends. In this way, a user does not need to perform excessive operations during the virtual match, and the virtual match can be completed as soon as possible. This ensures match efficiency of the virtual match.

In an implementation, the first battle information includes a plurality of first battle preparation combinations and at least one second battle preparation combination. The first battle combination includes two battle preparation areas and a connection line between the two battle preparation areas. One virtual piece is displayed in each battle preparation area, and the connection line between the two battle preparation areas indicates that the virtual pieces in the connected two battle preparation areas have a battle relationship. The second battle preparation combination includes two first battle preparation combinations and a connection line between the two first battle preparation combinations. First battle preparation combinations included in different second battle preparation combinations are completely different. The connection line between the two first battle preparation combinations indicates that winners of the two first battle preparation combinations have a battle relationship.

In the embodiments of this application, the plurality of first battle preparation combinations are equivalent to battle relationships between the plurality of virtual pieces in a previous round of the virtual match, and the at least one second battle preparation combination indicates a battle relationship between winners among the plurality of virtual pieces in the previous round in a subsequent round. That is, the first battle information indicates the battle relationships between the plurality of virtual pieces in the plurality of rounds of the virtual match. In this way, when the virtual match starts subsequently, battles in the plurality of rounds can be directly conducted according to the first battle information, to enrich content included in the first battle information. This ensures a display effect.

In an embodiment, when the first battle information includes a plurality of second battle preparation combinations, the first battle information further includes at least one third battle preparation combination. The third battle preparation combination includes two second battle preparation combinations and a connection line between the two second battle preparation combinations. Second battle preparation combinations included in different third battle preparation combinations are completely different. The connection line between the two second battle combinations indicates that winners of the two second battle preparation combinations have a battle relationship.

In the embodiments of this application, the at least one third battle preparation combination indicates a battle relationship between winners among the plurality of virtual pieces in the 2^{nd} round in the 3^{rd} round. That is, the first battle information indicates battle relationships between the plurality of virtual pieces in the 1^{st} round, the 2^{nd} round, and the 3^{rd} round of the virtual match. In this way, when the virtual match starts subsequently, the 1^{st} round, the 2^{nd} round, and the 3^{rd} round can be directly conducted according to the first battle information, to enrich content included in the first battle information. This ensures a display effect.

The embodiments of this application are described by using an example in which the first battle information includes the first battle preparation combination, the second battle preparation combination, and the third battle preparation combination. In another embodiment, when the first battle information includes a plurality of third battle preparation combinations, the first battle information may further include at least one fourth battle preparation combination. The fourth battle preparation combination includes two third battle preparation combinations and a connection line between the two third battle preparation combinations. Third battle preparation combinations included in different fourth battle preparation combinations are completely different. The connection line between the two third battle preparation combinations indicates that winners of the two third battle preparation combinations have a battle relationship. The first battle combination corresponds to the 1^{st} round of the virtual match, the second battle combination corresponds to the 2^{nd} round of the virtual battle, and the third battle combination corresponds to the 3^{rd} round of the virtual battle. According to the foregoing method, by analogy, a quantity of battle preparation combinations that are in the first battle information and that correspond to a last round of the virtual match is equal to 1. This ensures that a quantity of final winners is equal to 1 when the virtual match ends.

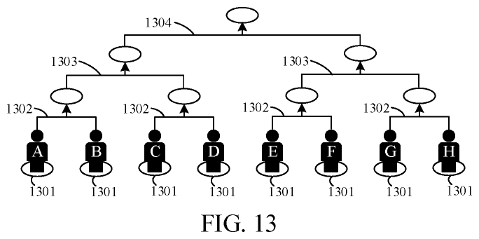

For example, a quantity of the plurality of virtual pieces participating in the virtual match is equal to 8. The match interface is shown in FIG. 13, the eight virtual pieces are a virtual piece A, a virtual piece B, a virtual piece C, a virtual piece D, a virtual piece E, a virtual piece F, a virtual piece G, and a virtual piece H, respectively. The first battle information includes four first battle preparation combinations, two second battle preparation combinations, and one third battle preparation combination. A circular area 1301 in FIG. 10 represents a battle preparation area included in the first battle preparation combination, and a line 1302 represents a connection line between two battle preparation areas. The four first battle preparation combinations are the virtual piece A and the virtual piece B, the virtual piece C and the virtual piece D, the virtual piece E and the virtual piece F, and the virtual piece G and the virtual piece H, respectively. A line 1303 is a connection line between two first preparation combinations. Two first preparation combinations in one second preparation combination are the virtual piece A and the virtual piece B, as well as the virtual piece C and a virtual piece D, and two first preparation combinations in the other second preparation combination are the virtual piece E and the virtual piece F, as well as the virtual piece G and the virtual piece H. A line 1304 is a connection line between the two second battle combinations. In this case, the first battle information displayed on the match interface indicates that in the virtual match.

The embodiments of this application are described by using an example in which the first battle information indicates the battle relationships between the plurality of virtual pieces in the plurality of rounds of the virtual match. In another embodiment, the first battle information indicates a battle relationship between the plurality of virtual pieces.
1202: The terminal displays, in response to the virtual match starting, that the plurality of virtual pieces engage in battle according to a battle relationship in the 1^{st} round.

In the embodiments of this application, after the virtual match starts, the 1^{st} round of the virtual match is entered, and the plurality of virtual pieces engage in battle according to the battle relationship in the 1^{st} round, to present a battle image of the plurality of virtual pieces. In this way, the participants can learn a battle situation of the plurality of virtual pieces by viewing the battle image through the terminal. This ensures a display effect and improves user experience.

Operation 1202 is similar to operation 302. Details are not described herein again.
1203: The terminal displays, when the j^{th} round ends, that a plurality of fourth virtual pieces engage in battle according to a battle relationship in the (j+1)^{th} round, j being an integer greater than 0, and the fourth virtual piece being a winner among the plurality of virtual pieces in the j^{th} round.

In the embodiments of this application, when the 1^{st} round ends, the 2^{nd} round is automatically entered, and it is displayed that winners among the plurality of virtual pieces in the 1^{st} round engage in battle according to a battle relationship in the 2^{nd} round. By analogy, after a previous round ends, a next round is automatically entered, and it is displayed that winners of the previous round engage in battle according to a battle relationship in the next round.

In an implementation, when the j^{th} round ends, victory prompt information of the j^{th} round is further displayed. Alternatively, when the j^{th} round ends, the plurality of fourth virtual pieces are displayed in a highlighted manner. Alternatively, when the j^{th} round ends, display of losers among the plurality of virtual pieces in the j^{th} round is canceled.

In the embodiments of this application, when the j^{th} round ends, not only the (j+1)^{th} round is automatically entered, but also the victory prompt information of the j^{th} round is displayed. Alternatively, the plurality of fourth virtual pieces are displayed in the highlighted manner. Alternatively, display of the losers among the plurality of virtual pieces in the j^{th} round is canceled. In this way, the participants can learn a situation of the virtual pieces participating in the (j+1)^{th} round by viewing displayed content through the terminal, and the participant learns a battle progress conveniently. This ensures a display effect.

The victory prompt information of the j^{th} round indicates the winner among the plurality of virtual pieces in the j^{th} round. The victory prompt information of the j^{th} round can be represented in any form. For example, the victory prompt information of the j^{th} round is represented in the form of text. For example, when the j^{th} round ends, it is displayed on a battle interface that the plurality of fourth virtual pieces engage in battle according to the battle relationship in the (j+1)^{th} round, and the victory prompt information of the j^{th} round is displayed at any position on the battle interface. The highlighted manner in which the plurality of fourth virtual pieces are displayed may be any manner. For example, highlighted haloes are displayed under the foots of the plurality of fourth virtual pieces, to display the plurality of fourth virtual pieces in the highlighted manner.

In the embodiments of this application, in addition to the plurality of fourth virtual pieces, there is another virtual piece in the virtual pieces participating in the j^{th} round, and the another virtual piece is the loser of the j^{th} round. When the j^{th} round ends, display of the loser of the j^{th} round is canceled, to ensure that only the winner of the j^{th} round is displayed, and the winner of the j^{th} round participates in the (j+1)^{th} round. This ensures a display effect.

The embodiments of this application are described by using an example in which the virtual match includes a plurality of rounds. In another embodiment, operation 1202 and operation 1203 do not need to be performed, and instead, the process of displaying, in response to the virtual match starting, that the plurality of virtual pieces engage in battle according to the battle relationship is implemented in another manner.
1204: The terminal displays victory prompt information on the match interface when the virtual match ends, the victory prompt information indicating a winner among the plurality of virtual pieces.

In the embodiments of this application, the end of the virtual match means that the plurality of rounds of the virtual match all end. When the virtual match ends, the victory prompt information is displayed on the match interface. The victory prompt information can indicate a winner of each round of the virtual match, or indicate a winner of the last round of the virtual match. In this way, the participants can learn a battle result by viewing the victory prompt information. For example, the quantity of virtual pieces participating in the virtual match is equal to 8. When the virtual match ends, the victory prompt information displayed on the match interface indicates which four virtual pieces are winners of the 1^{st} round, which two virtual pieces are winners of the 2^{nd} round, and which virtual piece is a winner of the 3^{rd} round.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

Based on the embodiment shown in FIG. 12, before the virtual match starts, when the quantity of virtual pieces displayed on the match interface is an odd number, the first battle information not only indicates the battle relationship between the virtual pieces engage in battle in each round, but also indicates a virtual piece not engaging in battle in each round. A virtual piece not engaging in battle in any round is randomly determined.

For example, nine virtual pieces are displayed on the match interface. The first battle information indicates that: in the 1^{st} round, a virtual piece 1 battles against a virtual piece 2, a virtual piece 3 battles against a virtual piece 4, a virtual piece 5 battle against a virtual piece 6, a virtual piece 7 battle against a virtual piece 8, and it is randomly determined that a virtual piece 9 does not engage in battle in the 1^{st} round. A winner of the battle between the virtual piece 1 and the virtual piece 2 is referred to as a first winner, a winner of the battle between the virtual piece 3 and the virtual piece 4 is referred to as a second winner, a winner of the battle between the virtual piece 5 and the virtual piece 6 is referred to as a third winner, and a winner of the battle between the virtual piece 7 and the virtual piece 8 is referred to as a fourth winner. In the 2^{nd} round, it is randomly determined that first winner does not engage in battle in the 2^{nd} round, the second winner battles against the third winner, and the fourth winner battles against the virtual piece 9. A winner of the battle between the second winner and the third winner is referred to as a fifth winner, and a winner of the battle between the fourth winner and the virtual piece 9 is referred to as a sixth winner. In the 3^{rd} round, it is randomly determined that the first winner does not engage in battle in the 3^{rd} round, and the fifth winner battles against the sixth winner. In the 4^{th} round, a winner of the battle between the fifth winner and the sixth winner battles against the first winner.

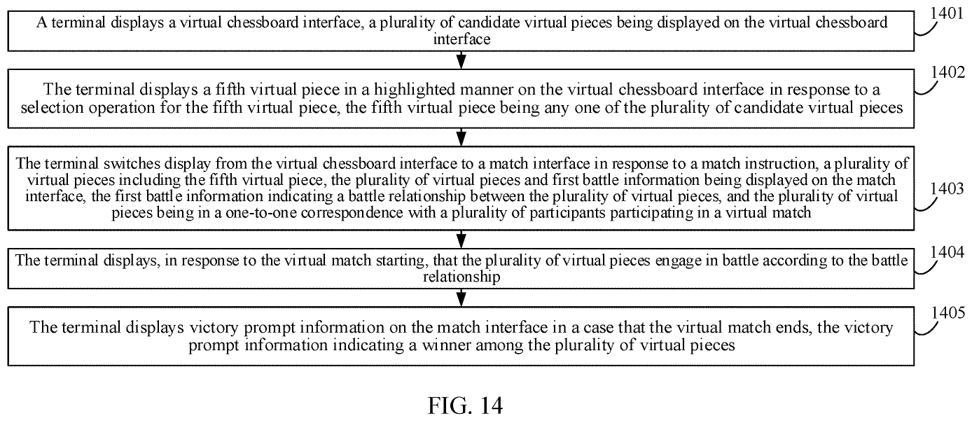

Based on the embodiment shown in FIG. 2, in the embodiments of this application, the participants can select, on a virtual chessboard interface through respective terminals, virtual pieces to participate in the virtual match. For details of a specific process, refer to the following embodiments. FIG. 14 is a flowchart of a match method according to an embodiment of this application. For example, the method is performed by a terminal. As shown in FIG. 14, the method includes:
1401: The terminal displays a virtual chessboard interface, a plurality of candidate virtual pieces being displayed on the virtual chessboard interface.

In the embodiments of this application, the candidate virtual pieces displayed on the virtual chessboard interface are candidate virtual pieces that can be selected by the participant corresponding to a local end. In this way, one virtual piece is selected from the plurality of candidate virtual pieces to participate in a subsequent virtual match.

In an implementation, a virtual chessboard is displayed on the virtual chessboard interface. The virtual chessboard includes a battle preparation area and a battle area, and the plurality of candidate virtual pieces may include candidate virtual pieces located in the battle preparation area, or may include candidate virtual pieces located in the battle area.

In the embodiments of this application, the candidate virtual piece in the battle preparation area is a virtual piece that has not engaged in battle during the round-based board game. The candidate virtual piece in the battle area is a virtual piece that may have engaged in battle during the round-based board game. Not only the candidate virtual piece in the battle preparation area can be used as virtual piece to subsequently participate in the virtual match, but also the candidate virtual piece in the battle area may be used as the virtual piece to subsequently participate in the virtual match. This can ensure flexibility in virtual piece selection.

In an embodiment, one game of the round-based board game includes a plurality of stages. Each stage includes a plurality of matches. The virtual match in the foregoing embodiments is referred to as an elite virtual match, and other matches in the round-based board game are referred to as ordinary virtual matches. A plurality of matches belonging to a same stage include one or more elite virtual matches. In a preparation time period of the ordinary virtual match, the terminal displays the virtual chessboard interface. The virtual chessboard includes the battle preparation area and the battle area. The plurality of participants participating in a same game can deploy the virtual pieces in the battle preparation area in the battle area through the virtual chessboard interface displayed by the terminal. In a battle time period of the ordinary virtual match, a game application pairs up the plurality of participants, and automatically controls virtual pieces deployed by both parties engaging in battle in the battle area. In the embodiments of this application, in the same game of the round-based board game, not only the ordinary virtual match is conducted, but also the elite virtual battle is conducted. This enriches match methods of the round-based board game, ensures a battle effect, and improves user experience. For example, one game of the round-based board game includes 7 stages, each stage includes 7 matches, first 6 battles in each stage are ordinary virtual matches, and the 7^{th} match in each stage is an elite virtual match.

In an embodiment, when a previous ordinary virtual match ends and a next match is the elite virtual match, the virtual chessboard interface is displayed. The plurality of candidate virtual pieces are displayed on the virtual chessboard interface. In this way, one virtual piece can be subsequently selected from the plurality of candidate virtual pieces to participate in the next elite virtual match.

For example, one game of the round-based board game includes a plurality of stages. Each stage includes a plurality of match. A last match in each stage is an elite virtual match, and remaining matches are ordinary virtual matches. When a current game starts, health points of virtual chess players controlled by the plurality of participants participating in the current game are the same, for example, all are 100. During the current game, health points of a virtual chess player controlled by a participant that is among the plurality of participants and that loses the battle are deducted upon the end of each stage or each match. When health points of a virtual chess player drop to 0, a participant corresponding to the virtual chess player is eliminated.

In an implementation, piece prompt information is displayed on the virtual chessboard interface. The piece prompt information is configured for prompting to select one virtual piece from the plurality of candidate virtual pieces to participate in a subsequent virtual match. For example, the piece prompt information is “Select one elite piece to engage in battle”.

In the embodiments of this application, not only the plurality of candidate virtual pieces are displayed on the virtual chessboard interface, but also the piece prompt information is displayed. In this way, a user can learn how to select a virtual piece. This implements a game guidance function, improves a display effect, and also improves user experience.
1402: The terminal displays a fifth virtual piece in a highlighted manner on the virtual chessboard interface in response to a selection operation for the fifth virtual piece, the fifth virtual piece being any one of the plurality of candidate virtual pieces.

In the embodiments of this application, the candidate virtual pieces displayed on the virtual chessboard interface are candidate virtual pieces that can be selected by the participant corresponding to the local end, and the user can select any candidate virtual piece from the plurality of candidate virtual pieces through the terminal. The selected candidate virtual piece is displayed in the highlighted manner on the virtual chessboard interface, to prompt a currently selected virtual piece. In the embodiments of this application, the fifth virtual piece can be displayed in any highlighted manner. For example, the fifth virtual piece is displayed in an enlarged manner on the virtual chessboard interface. Alternatively, a halo is displayed around the fifth virtual piece.

In an implementation, a virtual chessboard is displayed on the virtual chessboard interface. The virtual chessboard includes a battle preparation area and a battle area. The plurality of candidate virtual pieces include a candidate virtual piece located in the battle preparation area, and also include a candidate virtual piece located in the battle area. The fifth virtual piece is any virtual piece in the battle preparation area, or is any virtual piece in the battle area.

In an implementation, when the piece prompt information is displayed on the virtual chessboard interface, the piece prompt information further includes a filling position. The filling position is used for filling an identifier of a selected virtual piece. In this case, in response to the selection operation for the fifth virtual piece, an identifier of the fifth virtual piece is displayed in the piece prompt information. The identifier of the virtual piece can be represented in any form. For example, the identifier of the virtual piece is represented by a name of the virtual piece. In the embodiments of this application, when the fifth virtual piece is selected, not only the fifth virtual piece is displayed in the highlighted manner on the virtual chessboard interface, but also the piece prompt information is displayed on the virtual chessboard interface, to prompt the currently selected virtual piece. In this way, the user can learn the currently selected virtual piece. This avoids a case that the user cannot learn the currently selected virtual piece due to a misoperation, enriches displayed content, ensures a display effect, and also improves user experience.

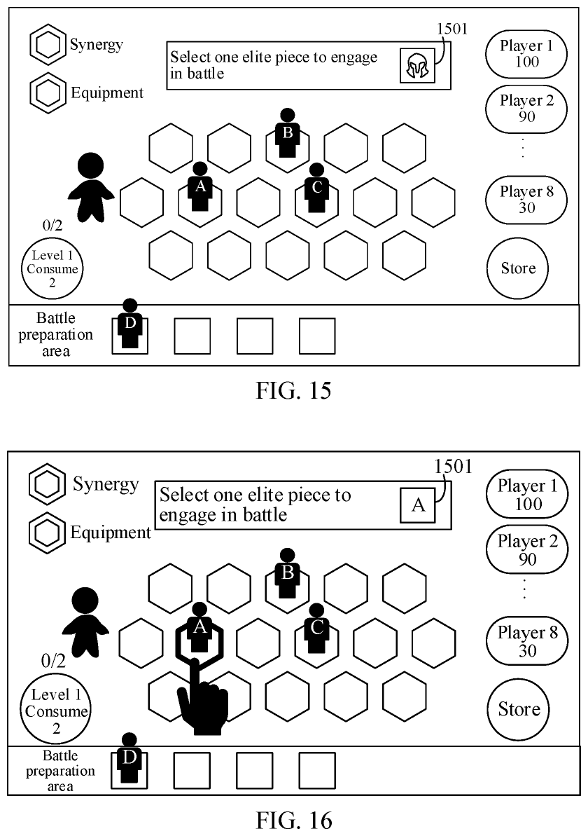

For example, the virtual chessboard interface is shown in FIG. 15. The virtual chessboard interface includes the battle area and the battle preparation area of the virtual chessboard. A virtual piece A, a virtual piece B, and a virtual piece C are displayed in the battle area, and a virtual piece D is displayed in the battle preparation area. In addition, a plurality of pieces of participant information are further displayed on the right side of the virtual chessboard interface, and piece prompt information is displayed on the virtual chessboard interface. When no virtual piece is selected, as shown in FIG. 15, the piece prompt information is “Select one elite piece to engage in battle”. Furthermore, a filling position 1501 is displayed in the piece prompt information. If the participant triggers a selection operation for the virtual piece A on a virtual chessboard interface through the terminal, a displayed virtual chessboard interface is shown in FIG. 16. An area occupied by the virtual piece A on the virtual chessboard is displayed in a highlighted manner, to display the selected virtual piece A in a highlighted manner. In addition, the filling location 1501 included in the piece prompt information is filled with an identifier “A” of the virtual piece A.

In an implementation, the method further includes: displaying prompt information in response to the selection operation for the fifth virtual piece, the prompt information indicating an ability value comparison result of the fifth virtual piece and an unselected piece. The unselected piece refers to a virtual piece other than the fifth virtual piece in the plurality of candidate virtual pieces. The ability value is used for representing a battle ability of the virtual piece. A larger ability value of a virtual piece indicates a stronger battle ability of the virtual piece, and a larger probability that the virtual piece defeats another virtual piece. The ability value can be any type of ability value. For example, the ability value of the virtual piece is attack power of the virtual piece, or a sum of attack power and a defense value of the virtual piece. The ability value comparison result indicates an ability value comparison situation of the fifth virtual piece and the unselected piece. For example, the ability value comparison result indicates whether the ability value of the fifth virtual piece is greater than the ability value of the unselected piece. If there is an unselected piece whose ability value is greater than the ability value of the fifth virtual piece, the unselected piece is further prompted.

In the embodiments of this application, when the fifth virtual chessboard interface is selected, the prompt information is further displayed on the virtual chessboard interface, to indicate the ability value comparison result of the fifth virtual piece and another unselected virtual piece, which reflects whether the fifth virtual piece has a maximum ability value among the plurality of candidate virtual pieces. In this way, the user can learn whether the ability value of the selected virtual piece is sufficiently large. This provides guidance for the user to select the virtual piece with the maximum ability value, facilitates selection by the user, enables the user to select the virtual piece with the maximum ability value to participate in a subsequent virtual math, ensure a possibility that the user wins the subsequent virtual match, and improves user experience.

In an embodiment, the prompt information includes first prompt information or second prompt information. The first prompt information indicates that the fifth virtual piece has the maximum ability value among the plurality of candidate virtual pieces, and the second prompt information indicates that the fifth virtual piece does not have the maximum ability value among the plurality of candidate virtual pieces. In an embodiment, the second prompt information further indicates a candidate virtual piece with the maximum ability value among the plurality of candidate virtual pieces. In the embodiments of this application, when the fifth virtual piece does not have the maximum ability value among the plurality of candidate virtual pieces, the second prompt information not only can indicate that the fifth virtual piece does not have the maximum ability value among the plurality of candidate virtual pieces, but also can indicate a candidate virtual piece with the maximum ability value, to provide guidance for the user to select a virtual piece. This facilitates user operations, improves user experience, and also improves human-computer interaction efficiency.

In an embodiment, the method further includes: displaying a sixth virtual piece in a highlighted manner on the virtual chessboard interface when the prompt information indicates that the fifth virtual piece does not have the maximum ability value among the plurality of candidate virtual pieces, the sixth virtual piece being a virtual piece with the maximum ability value among the plurality of candidate virtual pieces. In the embodiments of this application, when the fifth virtual piece does not have the maximum ability value among the plurality of candidate virtual pieces, the virtual piece with the maximum ability value among the plurality of candidate virtual pieces is displayed in the highlighted manner on the virtual chessboard interface, to provide guidance for the user to select a virtual piece. This facilitates a user operation, and allows the user to select the virtual piece with the maximum capability value as soon as possible without selecting virtual pieces one by one, improves human-computer interaction efficiency, and also improves user experience. In the embodiments of this application, the sixth virtual piece can be displayed in any highlighted manner, and the highlighted manner in which the sixth virtual piece is displayed is different from the highlighted manner in which the fifth virtual piece is displayed. For example, the sixth virtual piece is displayed in an enlarged manner on the virtual chessboard interface. Alternatively, a halo is displayed around the sixth virtual piece. 1403: The terminal switches display from the virtual chessboard interface to a match interface in response to a match instruction, a plurality of virtual pieces including the fifth virtual piece, the plurality of virtual pieces and first battle information being displayed on the match interface, the first battle information indicating a battle relationship between the plurality of virtual pieces, and the plurality of virtual pieces being in a one-to-one correspondence with a plurality of participants participating in a virtual match.

In the embodiments of this application, the candidate virtual pieces displayed on the virtual chessboard interface are candidate virtual pieces that can be selected by the participant corresponding to the local end, and the user can select any candidate virtual piece from the plurality of candidate virtual pieces through the terminal. The selected candidate virtual piece is displayed in the highlighted manner on the virtual chessboard interface, to prompt the currently selected virtual piece and to prompt that the selected virtual piece participates in the subsequent virtual match with another participant. In response to the match instruction, display is switched from the virtual chessboard interface to the match interface. This facilitates virtual piece selection by the user, and ensures flexibility in virtual piece selection by the user. In addition, the virtual pieces selected by the plurality of participants participating in the virtual match can be displayed on the match interface. In this way, the participants can learn a match situation of the subsequent virtual match by viewing the virtual pieces displayed on the match interface. This ensures a display effect and improves user experience. The match instruction indicates that the virtual match is about to start. In an embodiment, when the terminal displays the virtual chessboard interface, a first countdown is displayed on the virtual chessboard interface. When the first countdown ends, which is equivalent to receiving the match instruction, display is switched from the virtual chessboard interface to the match interface. A duration corresponding to the first countdown is equivalent to a duration provided for the participant to select a virtual piece, and the participants can select, within the duration, a virtual piece to participate in the subsequent virtual match.

The embodiments of this application are described by using an example in which the virtual pieces participating in the virtual match are selected through the virtual chessboard interface. In another embodiment, operation 1401 to operation 1403 do not need to be performed, and instead, the process of displaying the match interface of the round-based board game is implemented in another manner.
1404: The terminal displays, in response to the virtual match starting, that the plurality of virtual pieces engage in battle according to the battle relationship.
1405: The terminal displays victory prompt information on the match interface when the virtual match ends, the victory prompt information indicating a winner among the plurality of virtual pieces.

Operation 1404 and operation 1405 are similar to operation 202 and operation 203. Details are not described herein again.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

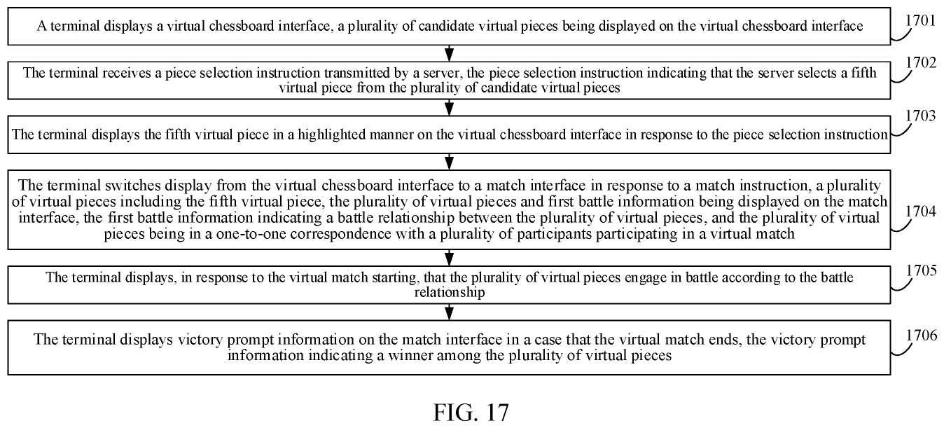

Based on the embodiment shown in FIG. 2, in the embodiments of this application, a server can select, for each participant, a virtual piece to participate in the virtual match. For details of a specific process, refer to the following embodiments. FIG. 17 is a flowchart of a match method according to an embodiment of this application. For example, the method is performed by a terminal. As shown in FIG. 17, the method includes:
1701
: The terminal displays a virtual chessboard interface, a plurality of candidate virtual pieces being displayed on the virtual chessboard interface.

Operation 1701 is similar to operation 1401. Details are not described herein again. 1702: The terminal receives a piece selection instruction transmitted by a server, the piece selection instruction indicating that the server selects a fifth virtual piece from the plurality of candidate virtual pieces.

The fifth virtual piece is a virtual piece automatically selected by the server from the plurality of candidate virtual pieces. The server is configured to provide a service for a round-based board game.

In an implementation, the server selects, based on ability values of the plurality of candidate virtual pieces, the fifth virtual piece from the plurality of candidate virtual pieces, and transmits the piece selection instruction to the terminal. In the embodiments of this application, the fifth virtual piece is a virtual piece with a maximum ability value among the plurality of candidate virtual pieces. The server automatically selects the virtual piece with the maximum ability value for the terminal without the need for manual selection by a user. This improves human-computer interaction efficiency, ensures a possibility of winning a subsequent virtual match, and improves user experience.

In an implementation, when a second countdown for selecting a piece ends and the server has not received a piece selection notification transmitted by the terminal, the server selects the fifth virtual piece from the plurality of candidate virtual pieces and transmits the piece selection instruction to the terminal. In the embodiments of this application, when the terminal displays the virtual chessboard interface, the participant can trigger a selection operation for any candidate virtual piece on the virtual chessboard interface through the terminal, to indicate that the selected candidate virtual piece is used as a virtual piece to subsequently participate in a virtual match. In addition, when the terminal detects a selection operation for any one of the plurality of candidate virtual pieces, the terminal transmits the piece selection notification to the server, to notify the server of the virtual piece selected by the terminal. The server can learn, based on a selection request, the virtual piece selected by the terminal. A duration of the second countdown is a time period provided for the participant to select a virtual piece. When the second countdown for selecting a piece ends and the terminal has not received the piece selection notification transmitted by the terminal, it indicates that the participant does not select a virtual piece, and the server automatically selects a virtual piece for the participant. In this way, the participant can successfully participate in the subsequent virtual match. In addition, manual selection by the participant is not required. This not only improves human-computer interaction efficiency, but also ensures the normal progress of the round-based board game. In an embodiment, the server determines the capability value of each candidate virtual piece based on data of the plurality of candidate virtual pieces on the virtual chessboard interface, and determines a candidate virtual piece with a maximum ability value as the fifth virtual piece. The data of the candidate virtual piece is configured for describing an ability of the candidate virtual piece. In the embodiments of this application, the server stores the data of each candidate virtual piece. The data of the candidate virtual pieces stored in the server is transmitted by the terminal to the server in real time. Alternatively, the terminal transmits the piece selection request to the server in response to the second countdown ending. The piece selection request carries the data of plurality of candidate virtual pieces, to indicate that the server selects the virtual piece with the maximum ability value from the plurality of candidate virtual pieces. The server receives the piece selection request, and obtains the carried data of the plurality of candidate virtual pieces.
1703: The terminal displays the fifth virtual piece in a highlighted manner on the virtual chessboard interface in response to the piece selection instruction.

In the embodiments of this application, the terminal can receive the piece selection instruction transmitted by the server. The piece selection instruction indicates that the server automatically selects the fifth virtual piece from the plurality of candidate virtual pieces, and displays the virtual piece selected by the server in the highlighted manner on a virtual chessboard. In this way, a method for automatically selecting a virtual piece is implemented without the need for manual piece selection by a user. This ensures convenience of virtual piece selection, improves human-computer interaction efficiency, and also improves user experience.

In an implementation, when the terminal displays the virtual chessboard interface, a first countdown is displayed on the virtual chessboard interface. When the first countdown ends, it is equivalent to receiving a match instruction. When a second countdown for selecting a piece ends and the server has not received a piece selection notification transmitted by the terminal, the server selects the fifth virtual piece from the plurality of candidate virtual pieces, and transmits the piece selection instruction to the terminal. A duration corresponding to the second countdown is shorter than a duration corresponding to the first countdown.

For example, the duration corresponding to the first countdown is 20 seconds, and the duration corresponding to the second countdown is 15 seconds. When the terminal displays the virtual chessboard interface, the first countdown and the second countdown start at the same time. In this case, the second countdown ends when the first countdown shows 5 seconds. If the terminal selects no virtual piece in this process, the terminal receives the piece selection instruction transmitted by the server, and displays the virtual piece selected by the server in the highlighted manner on the virtual chessboard interface.

Operation 1703 is similar to operation 1402. Details are not described herein again. The embodiments of this application are described by using an example in which the fifth virtual piece is selected through the piece selection instruction transmitted by the server. In another embodiment, the operation 1701 to operation 1703 do not need to be performed, and instead, the process of displaying the match interface of the round-based board game is implemented in another manner.
1704: The terminal switches display from the virtual chessboard interface to a match interface in response to a match instruction, a plurality of virtual pieces including the fifth virtual piece, the plurality of virtual pieces and first battle information being displayed on the match interface, the first battle information indicating a battle relationship between the plurality of virtual pieces, and the plurality of virtual pieces being in a one-to-one correspondence with a plurality of participants participating in a virtual match.

Operation 1704 is similar to operation 1403. Details are not described herein again.
1705: The terminal displays, in response to the virtual match starting, that the plurality of virtual pieces engage in battle according to the battle relationship.
1706: The terminal displays victory prompt information on the match interface when the virtual match ends, the victory prompt information indicating a winner among the plurality of virtual pieces.

Operation 1704 and operation 1705 are similar to operation 202 and operation 203. Details are not described herein again.

In the solutions provided in the embodiments of this application, in a virtual match of a round-based board game, a plurality of participants can respectively select one virtual piece to participate in a same virtual match. Before the virtual match starts, the plurality of virtual pieces participating in the virtual match and first battle information are displayed on a match interface. In this way, each participant can learn a subsequent match situation of the virtual match. After the virtual match starts, an image in which the plurality of virtual pieces engage in battle in a same scene according to a specified battle relationship is displayed, and finally victory prompt information indicating a winner among the plurality of virtual pieces is displayed. This implements a novel match method that allows each participant to independently select one virtual piece and allows the virtual pieces selected by the plurality of participants to compete together in a same arena. This mechanism integrates battle processes of virtual pieces selected by a plurality of parties into a same image, and presents a real-time battle scene according to a battle relationship. This enriches content displayed in a battle image, enhances appeal of the battle image compared to a conventional one-on-one chessboard layout mode, and improves an effect of the battle image. Meanwhile, a same-screen battle of the virtual pieces selected by the plurality of parties breaks a conventional one-on-one interaction mode, and allows the plurality of participants to form a close association within a same image. This enhances the connections among the plurality of participants, and improves an interactive effect among the plurality of participants during the round-based board game match. In addition, such as a battle method does not require players to perform complex operations for deploying pieces, improves human-computer interaction efficiency. Furthermore, the method has low requirements for players, and allows the players to win even without learning a piece layout manner. This can improve gaming experience of the players.

Based on the embodiment shown in FIG. 14 or FIG. 17, when a duration of displaying the victory prompt information on the match interface reaches a preset duration, the terminal switches display from the match interface to the virtual chessboard interface, and displays the ranking prompt information on the virtual chessboard interface. The ranking prompt information indicates the battle ranking of the participant corresponding to the local end in the virtual match The preset duration is any duration. For example, the preset duration is 20 seconds.

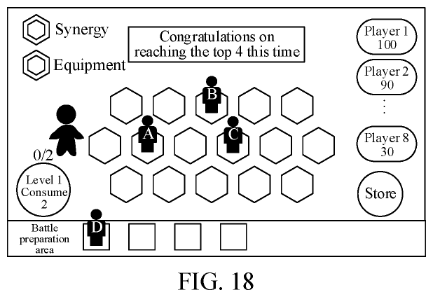

In the embodiments of this application, when the virtual match ends, the victory prompt information is displayed on the match interface, and when the duration of displaying the victory prompt information reaches the preset duration, display is switched from the match interface to the virtual chessboard interface, to display the ranking prompt information on the virtual chessboard interface. In this way, the participant can learn the battle ranking achieved in this virtual match. This improves an interactive effect and improves user experience. For example, after display is switched from the match interface to the virtual chessboard interface, the virtual chessboard interface is shown in FIG. 18, and the ranking prompt information displayed on the virtual chessboard interface is “Congratulations on reaching the top 4 this time”.

Based on the embodiments shown in FIG. 2 to FIG. 18, in the embodiments of this application, a reward can further be issued to the winner or a loser is punished based on the victory prompt information. That is, the method further includes: issuing a reward to the winner; or deducting health points corresponding to a loser. In the embodiments of this application, when the virtual battle ends, the reward can be issued to the winner of the virtual match or the health points corresponding to the loser can be deducted, to reflect a competitive sense of the virtual match. This can improve the interest of a player in participating in the virtual match, ensure fairness of the game, and improves user experience. The reward issued to the winner can be any reward. For example, the reward is a virtual prop, a virtual gold coin, or another type of virtual reward in the round-based board game. The health points corresponding to the loser are health points of a virtual piece corresponding to the loser, or health points of a virtual chess player played by a participant corresponding to the loser. For example, in any game of the round-based board game, the plurality of participants each correspond to one virtual chess player and the health points of the virtual chess player drop to 0, it indicates that the participant fails in the current game and is eliminated. In this case, the health points of the virtual chess player corresponding to the loser are deducted. This encourages progress of the current game and improves interaction of the game.

In an implementation, the virtual battle includes a plurality of rounds. In this case, the process of issuing the reward to the winner includes: issuing a reward to each participant based on battle rankings of the plurality of participants when the plurality of rounds all end. The battle rankings refer to rankings of the plurality of participants in the virtual match. For example, a battle ranking of the loser is top 8 or top 4. In the embodiments of this application, when the plurality of rounds all end, it indicates that the virtual match ends. In this case, the reward is issued to each participant based on the battle rankings of the plurality of participants. A higher battle ranking of the participant indicates a greater value of the reward issued to the participant, to reflect a competitive sense of the round-based board game. This can improve user experience. In an embodiment, in one game of the round-based board game, when the foregoing virtual match ends, another match is subsequently conducted. In this case, the reward is issued based on the victory prompt information in a preparation phase of a next match.

In an implementation, the deducting the health points corresponding to the loser includes: deducting the health points corresponding to the loser by a preset value; or deducting the health points corresponding to the loser based on a battle ranking of the loser. The preset value is any value. For example, the preset value is 10. The battle rankings refer to rankings of the plurality of participants in the virtual match. For example, a battle ranking of the loser is top 8 or top 4. In the embodiments of this application, when the virtual match ends, based on the victory prompt information, the health points corresponding to the loser are deducted by a fixed value (namely, a first value), or based on the battle ranking of the loser, the health points corresponding to the loser are deducted. A lower battle ranking of the loser indicates more deducted health points, to reflect that the loser receives corresponding punishment. This enriches reward and punishment methods of the round-based board games, increases the appeal to the user, and enhances user experience.

All of the foregoing embodiments can be combined in any manner to form exemplary embodiments of this application, which are not described herein one by one.

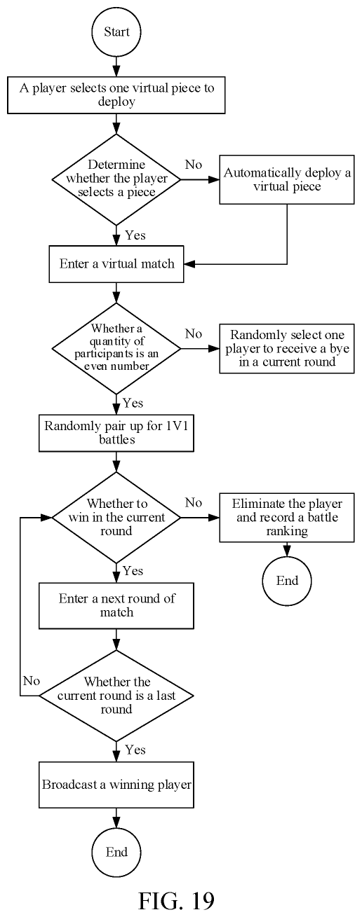

Based on the foregoing embodiments, the embodiments of this application further provide a flowchart of a match method. The virtual match in the foregoing embodiments is referred to as an elite virtual match. As shown in FIG. 19, the method includes:
Operation 1: A terminal displays a virtual chessboard interface before an elite virtual match starts, a plurality of candidate virtual pieces being displayed on the virtual chessboard interface, and the plurality of candidate virtual pieces including a virtual piece that has engaged in battle in a previous round and a virtual piece in a battle preparation area. A player can self-determine ability values of the candidate virtual pieces through the terminal, and select one virtual piece as a piece for engaging in battle in the subsequent elite virtual match.

In the embodiments of this application, if the player selects any virtual piece through the terminal, the terminal transmits a piece selection notification to a server, to notify the terminal of the selected virtual piece.
Operation 2: The terminal determines whether a player selects any virtual piece, that is, determines whether a selection operation for any virtual piece is detected.
Operation 3: If it is determined that the player selects any virtual piece, the terminal displays a match interface when first countdown ends.
Operation 4: If it is determined that the player does not select any virtual piece, the terminal receives a piece selection instruction transmitted by a server, displays the virtual piece selected by the server in a highlighted manner on a virtual chessboard interface in response to the piece selection instruction, and displays the match interface when the first countdown ends.
Operation 5: After entering a virtual match, each terminal transmits a participation notification to the server, to inform the server of participation of the terminal in the virtual match, and the server determines a quantity of participants of the virtual match based on the participation notifications, and determines whether the quantity of participants is an even number.
Operation 6: If the quantity of participants is an even number, the server randomly pairs up virtual pieces of the plurality of participants for 1V1 battles; or if the quantity of participants is an odd number, the server randomly selects a virtual piece of one participant from the plurality of participants to receive a bye in a current round and directly advance to a next round, and pairs up virtual pieces of remaining participants for 1V1 battles.
Operation 7: After the current round of the virtual match ends, the terminal determines whether a participant of a local end wins in the current round, and determines, if the participant of the local end wins in the current round, that the participant successfully advances to the next round; or determines, if the participant of the local end does not win in the current round, that the participant fails to advance to the next round, records a battle ranking of the participant of the local end, and cancels display of the virtual piece that fails in the current round on the match interface.
Operation 8: The terminal determines whether the current round is a last round, and conducts, if the current round is not the last round of the virtual match, the next round according to operation 5 to operation 7; or receives, if the current round is the last round of the virtual match, victory prompt information transmitted by the server, and displays the victory prompt information on the match interface, to broadcast a winning player.
Operation 9: After the last round of the virtual match ends, each terminal participating in the virtual match transmits a battle ranking to the server, the server stores the battle ranking corresponding to the terminal, obtains rewards respectively matching the battle rankings based on the battle rankings of the participants, and issues corresponding rewards to the terminals respectively corresponding to the participants.

In the embodiments of this application, during the virtual match, the terminals of the participants record the battle ranking of the participant of the local end. In another embodiment, the server records a battle situation of the virtual match in real time during the virtual match, that is, records the battle rankings of the participants in real time. In this case, when the last round of the virtual match ends, the server can obtain, according to operation 9 and based on the battle rankings of the participants, the rewards respectively matching the battle rankings, and issue the corresponding rewards to the terminals respectively corresponding to the participants.

The embodiments of this application provide a new battle playing method that is different from battling through piece formation matches. Each player selects only one virtual piece. Subsequently, virtual pieces selected by a plurality of players participating in a same game are paired up for battling on a same virtual chessboard. For example, a quantity of players participating in a same game is equal to 8. On the same chessboard, a pairwise battle manner is used in each round, battles in a plurality of rounds are conducted in three pairwise battle manners: top 8 to top 4, top 4 to top 2, and top 2 to champion. A winning player can deal health point damage to the virtual piece controlled by another player. After the virtual match ends, rewards are issued to the players based on rankings of the plurality of players in the virtual match. A higher battle ranking indicates greater value of the issued reward. That is, a higher battle ranking indicates a better reward. In this way, during the round-based board game, the player can cultivate a virtual piece with as high an ability value as possible to win in the elite virtual match, which affects a final battle result of the game, rather than being limited only by the influence of the piece formation match. This allows the player to adopt a plurality of strategies to achieve the final victory in the game, provides the player with diverse battle strategies, and enhances gameplay. In addition, for a player who is on a losing streak or is inexperienced and weak in lineup arrangement, this provides a way to turn defeat into victory, has low requirements for players, and allows players to win even when the players are unfamiliar with a piece layout manner.

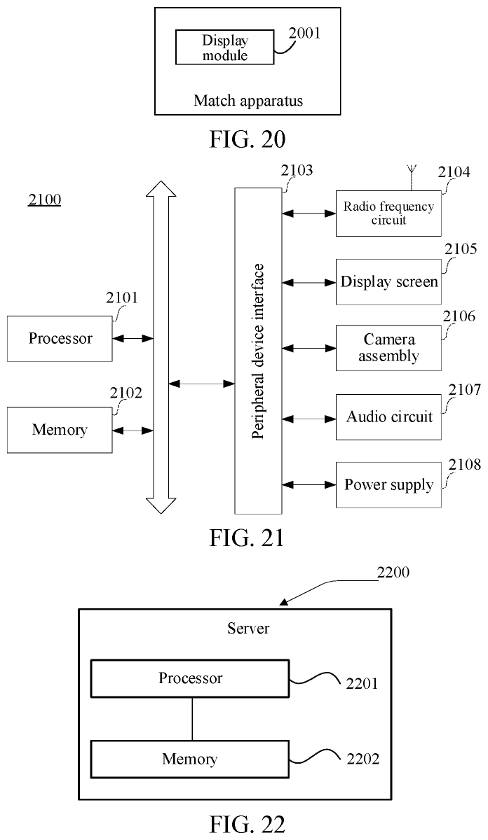

FIG. 20 is a schematic structural diagram of a match apparatus according to an embodiment of this application. As shown in FIG. 20, the apparatus includes:
a display module 2001, configured to display a match interface of a round-based board game, a plurality of virtual pieces and first battle information being displayed on the match interface, the first battle information indicating a battle relationship between the plurality of virtual pieces, and the plurality of virtual pieces being in a one-to-one correspondence with a plurality of participants participating in a virtual match;
the display module 2001 being further configured to display, in response to the virtual match starting, that the plurality of virtual pieces engage in battle according to the battle relationship; and
the display module 2001 being further configured to display victory prompt information on the match interface when the virtual battle ends, the victory prompt information indicating a winner among the plurality of virtual pieces.

In an implementation, the first battle information indicates a battle relationship between the plurality of virtual pieces in the i^{th} round of the virtual match, where i is an integer greater than 0. The display module 2001 is configured to display, in response to the i^{th} round starting, that the plurality of virtual pieces engage in battle according to the battle relationship in the i^{th} round.

The display module 2001 is configured to display victory prompt information of the i^{th} round on the match interface when the i^{th} round ends, the victory prompt information of the i^{th} round indicating a winner among the plurality of virtual pieces in the i^{th} round.

In another implementation, the display module 2001 is further configured to display second battle information on the match interface when the i^{th} round ends, the second battle information indicating a battle relationship between a plurality of first virtual pieces in the (i+1)^{th} round of the virtual match, and the first virtual piece being a winner among the plurality of virtual pieces in the i^{th} round.

The display module 2001 is further configured to display, in response to the (i+1)^{th} round starting, that the plurality of first virtual pieces engage in battle according to the battle relationship in the (i+1)^{th} round; and display victory prompt information of the (i+1)^{th} round on the match interface when the (i+1)^{th} round ends, the victory prompt information of the (i+1)^{th} round indicating a winner among the plurality of first virtual pieces in the (i+1)^{th} round.

In another implementation, a quantity of the plurality of virtual pieces is an odd number, the plurality of virtual pieces include a plurality of second virtual pieces and a third virtual piece, the first battle information indicates at least one battle combination in the i^{th} round and the third virtual piece not engaging in battle in the i^{th} round, the battle combination includes any two second virtual pieces having a battle relationship, and second virtual pieces included in different battle combinations are completely different. The display module 2001 is configured to display, in response to the i^{th} round starting, that the plurality of second virtual pieces engage in battle according to the battle relationship in the i^{th} round.

In another implementation, the display module 2001 is further configured to display third battle information on the match interface when the i^{th} round ends, the third battle information indicating a battle relationship between the plurality of first virtual pieces and the third virtual piece in the (i+1)^{th} round of the virtual match, a sum of a quantity of the plurality of first virtual pieces and a quantity of the third virtual piece being an even number, and the first virtual piece being a winner among the plurality of second virtual pieces in the i^{th} round.

The display module 2001 is further configured to display, in response to the (i+1)^{th} round starting, that the plurality of first virtual pieces and the third virtual piece engage in battle according to the battle relationship in the (i+1)^{th} round; and display victory prompt information of the (i+1)^{th} round on the match interface when the (i+1)^{th} round ends, the victory prompt information of the (i+1)^{th} round indicating a winner among the plurality of first virtual pieces and the third virtual piece in the (i+1)^{th} round.

In another implementation, the first battle information indicates battle relationships between the plurality of virtual pieces in a plurality of rounds of the virtual match. The display module 2001 is configured to display, in response to the virtual match starting, that the plurality of virtual pieces engage in battle according to a battle relationship in the 1^{st} round; and display, when the j^{th} round ends, that a plurality of fourth virtual pieces engage in battle according to a battle relationship in the (j+1)^{th} round, j being an integer greater than 0, and the fourth virtual piece being a winner among the plurality of virtual pieces in the j^{th} round.

In another implementation, the first battle information includes a plurality of first battle preparation combinations. The first battle preparation combination includes two battle preparation areas and a connection line between the two battle preparation areas. One virtual piece is displayed in each battle preparation area, and the connection line indicates that the virtual pieces in the two connected battle preparation areas have a battle relationship.

In another implementation, the first battle information further includes at least one second battle preparation combination. The second battle preparation combination includes two first battle preparation combinations and a connection line between the two first battle preparation combinations. First battle preparation combinations included in different second battle preparation combinations are completely different, and the connection line between the two first battle preparation combinations indicates that winners of the two first battle preparation combinations have a battle relationship.

In another implementation, the display module 2001 is further configured to display a virtual chessboard interface, a plurality of candidate virtual pieces being displayed on the virtual chessboard interface; and display a fifth virtual piece in a highlighted manner on the virtual chessboard interface in response to a selection operation for the fifth virtual piece, the fifth virtual piece being any one of the plurality of candidate virtual pieces.

The display module 2001 is configured to switch display from the virtual chessboard interface to the match interface in response to a match instruction, the plurality of virtual pieces including the fifth virtual piece.

In another implementation, the display module 2001 is further configured to display prompt information in response to the selection operation for the fifth virtual piece, the prompt information indicating an ability value comparison result of the fifth virtual piece and an unselected piece in the plurality candidate virtual pieces.

In another implementation, the display module 2001 is further configured to display a sixth virtual piece in a highlighted manner on the virtual chessboard interface when the prompt information indicates that the fifth virtual piece does not have a maximum ability value among the plurality of candidate virtual pieces, the sixth virtual piece being a virtual piece with the maximum ability value among the plurality of candidate virtual pieces.

In another implementation, the display module 2001 is further configured to receive a piece selection instruction transmitted by a server, the piece selection instruction indicating that the server selects the fifth virtual piece from the plurality of candidate virtual pieces; and display the fifth virtual piece in a highlighted manner on the virtual chessboard interface in response to the piece selection instruction.

In another implementation, the display module 2001 is further configured to issue a reward to the winner; or deduct health points corresponding to a loser.

In another implementation, the display module 2001 is further configured to deduct the health points corresponding to the loser by a preset value; or deduct the health points corresponding to the loser based on a battle ranking of the loser.

The match apparatus provided in the foregoing embodiments is described by only using the division of the foregoing function modules as an example. In practical application, the foregoing functions may be allocated to and completed by different function modules as required. That is, an internal structure of a computer device is divided into different function modules to complete all or some of the functions described above. In addition, the match apparatus provided in the foregoing embodiments and the match method embodiments belong to the same concept. For details of the specific implementation process of the match apparatus, refer to the method embodiments. Details are not described herein again.

The embodiments of this application further provide a computer device. The computer device includes a processor and a memory. The memory has at least one computer program stored therein, and the at least one computer program is loaded and executed by the processor to implement the operations performed in the match method according to the foregoing embodiments. In an embodiment, the computer device is provided as a terminal. FIG. 21 is a structural block diagram of a terminal 2100 according to an exemplary embodiment of this application. The terminal 2100 includes a processor 2101 and a memory 2102.

The processor 2101 may include one or more processing cores. For example, the processor may be a 4-core processor or an 8-core processor. The processor 2101 may be implemented by using at least one hardware form of a digital signal processor (DSP), a field-programmable gate array (FPGA), and a programmable logic array (PLC). The processor 2101 may alternatively include a main processor and a coprocessor. The main processor is configured to process data in an awake state, and is alternatively referred to as a central processing unit (CPU). The coprocessor is a low-power processor configured to process data in a standby mode. The memory 2102 may include one or more computer-readable storage media. The computer-readable storage media may be non-transitory. The memory 2102 may further include a high-speed random-access memory and a non-volatile memory, such as one or more disk storage devices and flash storage devices.

In some embodiments, the terminal 2100 may further include a peripheral device interface 2103 and at least one peripheral device. The processor 2101, the memory 2102, and the peripheral device interface 2103 may be connected via a bus or a signal cable. The peripheral devices may be connected to the peripheral interface 2103 via a bus, a signal cable, or a circuit board. Specifically, the peripheral device includes at least one of a radio frequency (RF) circuit 2104, a display screen 2105, a camera assembly 2106, an audio circuit 2107, and a power supply 2108.

The peripheral device interface 2103 may be configured to connect at least one input/output (I/O)-related peripheral device to the processor 2101 and the memory 2102.

The RF circuit 2104 is configured to receive and transmit an RF signal that is also referred to as an electromagnetic signal. The RF circuit 2104 communicates with a communication network and another communication device via electromagnetic signals. The RF circuit 2104 converts an electric signal into an electromagnetic signal for transmission, or converts a received electromagnetic signal into an electric signal. In an embodiment, the RF circuit 2104 includes: an antenna system, an RF transceiver, one or more amplifiers, a tuner, an oscillator, a DSP, a codec chip set, a subscriber identity module card, and the like. The RF circuit 2104 may communicate with another terminal by using at least one wireless communication protocol. The wireless communication protocol includes, but is not limited to, a world wide web, a metropolitan area network, an intranet, generations of mobile communication networks (2G, 3G, 4G, and 5G), a wireless local area network, and/or a wireless fidelity (Wi-Fi) network. In some embodiments, the RF circuit 2104 may further include a near field communication (NFC)-related circuit. This is not limited in this application.

The display screen 2105 is configured to display an UI. The UI may include a graphic, text, an icon, a video, and any combination thereof. When the display screen 2105 is a touch display screen, the display screen 2105 further has a capability to collect a touch signal on or above a surface of the display screen 2105. The touch signal may be inputted, as a control signal, into the processor 2101 for processing. In this case, the display screen 2105 may further be configured to provide a virtual button and/or a virtual keyboard that are/is also referred to as a soft button and/or a soft keyboard.

The camera assembly 2106 is configured to collect an image or a video. In an embodiment, the camera assembly 2106 includes a front-facing camera and a rear camera. The front-facing camera is arranged on a front panel of the terminal, and the rear camera is arranged on a back of the terminal. In some embodiments, at least two rear cameras are provided, which are respectively any of a main camera, a depth-of-field camera, a wide-angle camera, and a telephoto camera, to achieve a background blur function through fusion of the main camera and the depth-of-field camera, a panoramic photographing and virtual reality (VR) photographing function through fusion of the main camera and the wide-angle camera, or another fused photographing function.

The audio circuit 2107 may include a microphone and a speaker. The microphone is configured to collect sound waves of a user and an environment, and convert the sound waves into electrical signals and input the signals into the processor 2101 for processing, or input the signals into the RF circuit 2104 to implement voice communication. For the purpose of stereo sound collection or noise reduction, a plurality of microphones may be provided and respectively deployed at different parts of the terminal 2100. The microphone may further be an array microphone or an omnidirectional microphone. The speaker is configured to convert electrical signals from the processor 2101 or the radio circuit 2104 into sound waves. The speaker may be a conventional thin-film speaker or a piezoelectric ceramic speaker. When the speaker is a piezoelectric ceramic speaker, the speaker can not only convert electrical signals into sound waves audible to a human being, but also convert electrical signals into sound waves inaudible to the human being for ranging and another purpose. In some embodiments, the audio circuit 2107 may further include an earphone jack.

The power supply 2108 is configured to supply power to the components in the terminal 2100. The power supply 2108 may be an alternating current (AC) source, a direct current (DC) source, a primary battery, or a rechargeable battery. When the power supply 2108 includes a rechargeable battery, the rechargeable battery may be a wired rechargeable battery or a wireless rechargeable battery. The wired rechargeable battery is a battery charged through a wired line. The wireless rechargeable battery is a battery charged through a wireless coil. The rechargeable battery may further be configured to support a fast-charging technology.

A person skilled in the art may understand that the structure shown in FIG. 21 does not constitute a limitation on the terminal 2100, and more or fewer components than those shown in the figure may be included, or some components may be combined, or a different component deployment may be used.

In an embodiment, the computer device is provided as a server. FIG. 22 is a schematic structural diagram of a server according to an embodiment of this application. A server 2200 may vary depending on configuration or performance, and may include one or more CPUs 2201 and one or more memories 2202. The memory 2202 has at least one computer program stored therein, and the at least one computer program is loaded and executed by the processor 2201 to implement the method provided in the foregoing method embodiments. Certainly, the server may further have components such as a wired or wireless network interface, a keyboard, and an I/O interface for input and output. The server may further include another component for achieving a device function. Details are not described herein.

The embodiments of this application further provide a computer-readable storage medium. The computer-readable storage medium has at least one computer program stored therein, and the at least one computer program is loaded and executed by a processor to implement the operations performed in the match method according to the foregoing embodiments.

The embodiments of this application further provide a computer program product, including a computer program. The computer program, when executed by a processor, implements the operations performed in the match method according to the foregoing embodiments.

A person of ordinary skill in the art may understand that all or some of the operations implementing the foregoing embodiments may be implemented by hardware, or may be implemented by a program instructing relevant hardware. The program may be stored in a computer-readable storage medium. The storage medium may be a read-only memory, a disk, an optical disc, or the like.

The above descriptions are merely exemplary embodiments of the embodiments of this application, and are not intended to limit the embodiments of this application. Any modification, equivalent replacement, improvement, and the like made within the spirit and principle of the embodiments of this application fall within the scope of protection of this application.

What is claimed is:

1. A virtual match method performed by a computer device, the method comprising:
displaying a graphical user interface of a virtual chessboard, the virtual chessboard including a plurality of candidate virtual pieces;
in response to a selection operation for a new virtual piece, highlighting the new virtual piece on the virtual chessboard, the new virtual piece being any one of the plurality of candidate virtual pieces;
in response to a match initiation instruction, switching the graphical user interface from the virtual chessboard to a match interface having a plurality of virtual pieces including the new virtual piece and first battle information, the first battle information indicating a one-to-one battle relationship between the plurality of virtual pieces;
in response to a virtual match starting instruction, causing the plurality of virtual pieces to engage in one-to-one battles according to the one-to-one battle relationship; and
when the virtual match ends, displaying victory prompt information on the match interface identifying a winner among the plurality of virtual pieces.

2. The method according to claim 1, wherein the first battle information indicates a one-to-one battle relationship between the plurality of virtual pieces in an i^{th} round of the virtual match, wherein i is an integer greater than 0; and the causing the plurality of virtual pieces to engage in one-to-one battles according to the one-to-one battle relationship comprises:
in response to the i^{th} round starting, causing the plurality of virtual pieces to engage in the one-to-one battles according to the corresponding one-to-one battle relationship in the i^{th} round; and
the displaying victory prompt information on the match interface comprises:
displaying victory prompt information of the i^{th} round on the match interface when the i^{th} round ends, the victory prompt information of the i^{th} round indicating a winner among the plurality of virtual pieces in the i^{th} round.

3. The method according to claim 2, after the displaying, in response to the i^{th} round starting, that the plurality of virtual pieces engage in battle according to the battle relationship in the i^{th} round, further comprising:
displaying second battle information on the match interface when the i^{th} round ends, the second battle information indicating a battle relationship between a plurality of first virtual pieces in the (i+1)^{th} round of the virtual match, and the first virtual piece being a winner among the plurality of virtual pieces in the i^{th} round; and
after the displaying victory prompt information of the i^{th} round on the match interface when the i^{th} round ends, further comprising:
displaying, in response to the (i+1)^{th} round starting, that the plurality of first virtual pieces engage in battle according to the battle relationship in the (i+1)^{th} round; and
displaying victory prompt information of the (i+1)^{th} round on the match interface when the (i+1)^{th} round ends, the victory prompt information of the (i+1)^{th} round indicating a winner among the plurality of first virtual pieces in the (i+1)^{th} round.

4. The method according to claim 2, wherein a quantity of the plurality of virtual pieces is an odd number, the plurality of virtual pieces comprise a plurality of second virtual pieces and a third virtual piece, the first battle information indicates at least one battle combination in the i^{th} round and the third virtual piece not engaging in battle in the i^{th} round, the battle combination comprises any two second virtual pieces having a battle relationship, and second virtual pieces comprised in different battle combinations are completely different; and
displaying, in response to the i^{th} round starting, that the plurality of virtual pieces engage in battle according to the battle relationship in the i^{th} round comprises:
displaying, in response to the i^{th} round starting, that the plurality of second virtual pieces engage in battle according to the battle relationship in the i^{th} round.

5. The method according to claim 4, after the displaying, in response to the i^{th} round starting, that the plurality of virtual pieces engage in battle according to the battle relationship in the i^{th} round, further comprising:
displaying third battle information on the match interface when the i^{th} round ends, the third battle information indicating a battle relationship between the plurality of first virtual pieces and the third virtual piece in the (i+1)^{th} round of the virtual match, a sum of a quantity of the plurality of first virtual pieces and a quantity of the third virtual piece being an even number, and the first virtual piece being a winner among the plurality of second virtual pieces in the i^{th} round; and
after the displaying victory prompt information of the i^{th} round on the match interface when the i^{th} round ends, further comprising:
displaying, in response to the (i+1)^{th} round starting, that the plurality of first virtual pieces and the third virtual piece engage in battle according to the battle relationship in the (i+1)^{th} round;
and displaying victory prompt information of the (i+1)^{th} round on the match interface when the (i+1)^{th} round ends, the victory prompt information of the (i+1)^{th} round indicating a winner among the plurality of first virtual pieces and the third virtual piece in the (i+1)^{th} round.

6. The method according to claim 1, wherein the first battle information indicates the one-to-one battle relationships between the plurality of virtual pieces in a plurality of rounds of the virtual match; and the causing the plurality of virtual pieces to engage in one-to-one battles according to the one-to-one battle relationship comprises:
in response to the virtual match starting, displaying that the plurality of virtual pieces engage in battle according to a battle relationship in the 1^{st} round; and
when the j^{th} round ends, displaying that a plurality of fourth virtual pieces engage in battle according to a battle relationship in the (j+1)^{th} round, j being an integer greater than 0, and the fourth virtual piece being a winner among the plurality of virtual pieces in the j^{th} round.

7. The method according to claim 1, wherein the first battle information comprises a plurality of first battle preparation combinations, the first battle preparation combination comprises two battle preparation areas and a connection line between the two battle preparation areas, one virtual piece is displayed in each battle preparation area, and the connection line indicates that the virtual pieces in the two connected battle preparation areas have a battle relationship.

8. The method according to claim 7, wherein the first battle information further comprises at least one second battle preparation combination, the second battle preparation combination comprises two first battle preparation combinations and a connection line between the two first battle preparation combinations, first battle preparation combinations comprised in different second battle preparation combinations are completely different, and the connection line between the two first battle preparation combinations indicates that winners in the two first battle preparation combinations have a battle relationship.

9. The method according to claim 1, further comprising:
in response to the selection operation for the new virtual piece, displaying prompt information indicating an ability value comparison result of the new virtual piece and an unselected piece.

10. A computer device, comprising a processor and a memory, the memory having at least one computer program stored therein, and the at least one computer program, when executed by the processor, causing the computer device to implement operations performed in a virtual match method including:
displaying a graphical user interface of a virtual chessboard, the virtual chessboard including a plurality of candidate virtual pieces;
in response to a selection operation for a new virtual piece, highlighting the new virtual piece on the virtual chessboard, the new virtual piece being any one of the plurality of candidate virtual pieces;
in response to a match initiation instruction, switching the graphical user interface from the virtual chessboard to a match interface having a plurality of virtual pieces including the new virtual piece and first battle information, the first battle information indicating a one-to-one battle relationship between the plurality of virtual pieces;
in response to a virtual match starting instruction, causing the plurality of virtual pieces to engage in one-to-one battles according to the one-to-one battle relationship; and
when the virtual match ends, displaying victory prompt information on the match interface identifying a winner among the plurality of virtual pieces.

11. The computer device according to claim 10, wherein the first battle information indicates a one-to-one battle relationship between the plurality of virtual pieces in an i^{th} round of the virtual match, wherein i is an integer greater than 0; and the causing the plurality of virtual pieces to engage in one-to-one battles according to the one-to-one battle relationship comprises:
in response to the i^{th} round starting, causing the plurality of virtual pieces to engage in the one-to-one battles according to the corresponding one-to-one battle relationship in the i^{th} round; and
the displaying victory prompt information on the match interface comprises:
displaying victory prompt information of the i^{th} round on the match interface when the i^{th} round ends, the victory prompt information of the i^{th} round indicating a winner among the plurality of virtual pieces in the i^{th} round.

12. The computer device according to claim 11, wherein, after the displaying, in response to the i^{th} round starting, that the plurality of virtual pieces engage in battle according to the battle relationship in the i^{th} round, the method further comprises:
displaying second battle information on the match interface when the i^{th} round ends, the second battle information indicating a battle relationship between a plurality of first virtual pieces in the (i+1)^{th} round of the virtual match, and the first virtual piece being a winner among the plurality of virtual pieces in the i^{th} round; and
after the displaying victory prompt information of the i^{th} round on the match interface when the i^{th} round ends, further comprising:
displaying, in response to the (i+1)^{th} round starting, that the plurality of first virtual pieces engage in battle according to the battle relationship in the (i+1)^{th} round; and
displaying victory prompt information of the (i+1)^{th} round on the match interface when the (i+1)^{th} round ends, the victory prompt information of the (i+1)^{th} round indicating a winner among the plurality of first virtual pieces in the (i+1)^{th} round.

13. The computer device according to claim 11, wherein a quantity of the plurality of virtual pieces is an odd number, the plurality of virtual pieces comprise a plurality of second virtual pieces and a third virtual piece, the first battle information indicates at least one battle combination in the i^{th} round and the third virtual piece not engaging in battle in the i^{th} round, the battle combination comprises any two second virtual pieces having a battle relationship, and second virtual pieces comprised in different battle combinations are completely different;
and displaying, in response to the i^{th} round starting, that the plurality of virtual pieces engage in battle according to the battle relationship in the i^{th} round comprises:
displaying, in response to the i^{th} round starting, that the plurality of second virtual pieces engage in battle according to the battle relationship in the i^{th} round.

14. The computer device according to claim 13, wherein, after the displaying, in response to the i^{th} round starting, that the plurality of virtual pieces engage in battle according to the battle relationship in the i^{th} round, the method further comprises:
displaying third battle information on the match interface when the i^{th} round ends, the third battle information indicating a battle relationship between the plurality of first virtual pieces and the third virtual piece in the (i+1)^{th} round of the virtual match, a sum of a quantity of the plurality of first virtual pieces and a quantity of the third virtual piece being an even number, and the first virtual piece being a winner among the plurality of second virtual pieces in the i^{th} round; and
after the displaying victory prompt information of the i^{th} round on the match interface when the i^{th} round ends, further comprising:
displaying, in response to the (i+1)^{th} round starting, that the plurality of first virtual pieces and the third virtual piece engage in battle according to the battle relationship in the (i+1)^{th} round; and
displaying victory prompt information of the (i+1)^{th} round on the match interface when the (i+1)^{th} round ends, the victory prompt information of the (i+1)^{th} round indicating a winner among the plurality of first virtual pieces and the third virtual piece in the (i+1)^{th} round.

15. The computer device according to claim 10, wherein the first battle information indicates the one-to-one battle relationships between the plurality of virtual pieces in a plurality of rounds of the virtual match; and the causing the plurality of virtual pieces to engage in one-to-one battles according to the one-to-one battle relationship comprises:
in response to the virtual match starting, displaying that the plurality of virtual pieces engage in battle according to a battle relationship in the 1^{st} round; and
when the j^{th} round ends, displaying that a plurality of fourth virtual pieces engage in battle according to a battle relationship in the (j+1)^{th} round, j being an integer greater than 0, and the fourth virtual piece being a winner among the plurality of virtual pieces in the j^{th} round.

16. The computer device according to claim 10, wherein the first battle information comprises a plurality of first battle preparation combinations, the first battle preparation combination comprises two battle preparation areas and a connection line between the two battle preparation areas, one virtual piece is displayed in each battle preparation area, and the connection line indicates that the virtual pieces in the two connected battle preparation areas have a battle relationship.

17. The computer device according to claim 16, wherein the first battle information further comprises at least one second battle preparation combination, the second battle preparation combination comprises two first battle preparation combinations and a connection line between the two first battle preparation combinations, first battle preparation combinations comprised in different second battle preparation combinations are completely different, and the connection line between the two first battle preparation combinations indicates that winners in the two first battle preparation combinations have a battle relationship.

18. The computer device according to claim 10, wherein the method further comprises:
in response to the selection operation for the new virtual piece, displaying prompt information indicating an ability value comparison result of the new virtual piece and an unselected piece.

19. A non-transitory computer-readable storage medium, having at least one computer program stored therein, the at least one computer program, when executed by a processor of a computer device, causing the computer device to implement operations performed in a virtual match method including:
displaying a graphical user interface of a virtual chessboard, the virtual chessboard including a plurality of candidate virtual pieces;
in response to a selection operation for a new virtual piece, highlighting the new virtual piece on the virtual chessboard, the new virtual piece being any one of the plurality of candidate virtual pieces;
in response to a match initiation instruction, switching the graphical user interface from the virtual chessboard to a match interface having a plurality of virtual pieces including the new virtual piece and first battle information, the first battle information indicating a one-to-one battle relationship between the plurality of virtual pieces;
in response to a virtual match starting instruction, causing the plurality of virtual pieces to engage in one-to-one battles according to the one-to-one battle relationship; and
when the virtual match ends, displaying victory prompt information on the match interface identifying a winner among the plurality of virtual pieces.

20. The non-transitory computer-readable storage medium according to claim 19, wherein the first battle information indicates a one-to-one battle relationship between the plurality of virtual pieces in an i^{th} round of the virtual match, wherein i is an integer greater than 0; and
the causing the plurality of virtual pieces to engage in one-to-one battles according to the one-to-one battle relationship comprises:
in response to the i^{th} round starting, causing the plurality of virtual pieces to engage in the one-to-one battles according to the corresponding one-to-one battle relationship in the i^{th} round; and
the displaying victory prompt information on the match interface comprises:
displaying victory prompt information of the i^{th} round on the match interface when the i^{th} round ends, the victory prompt information of the i^{th} round indicating a winner among the plurality of virtual pieces in the i^{th} round.
